(19) United States
(12) Patent Application Publication
(10) Pub. No.: US 2025/0299105 A1
(43) Pub. Date: Sep. 25, 2025

(54) LOCALIZED MACHINE LEARNING FOR MONITORING WITH DATA PRIVACY

(71) Applicant: LogicMark, Inc., Louisville, KY (US)

(72) Inventors: Chia-Lin Simmons, Moraga, CA (US); Rafael Saavedra, Cupertino, CA (US); Peter Williams, Belmont, CA (US)

(21) Appl. No.: 19/088,709

(22) Filed: Mar. 24, 2025

Related U.S. Application Data
(60) Provisional application No. 63/569,458, filed on Mar. 25, 2024.

(51) Int. Cl. G06N 20/00

(52) U.S. Cl. CPC G06N 20/00

(57) ABSTRACT

Localized machine learning for monitoring with data privacy may be provided via receiving for monitoring a particular person under monitoring (PUM) in a particular sensor enabled environment (SEE), an artificial intelligence or machine learning (AI/ML) model, the AI/ML model including sensor settings and activity patterns for monitoring a PUM in a SEE; localizing the AI/ML model as an edge AI/ML model; monitoring sensor data from the sensors to monitor the particular PUM; identifying candidate next states for the particular PUM and SEE based on the current state and the activity patterns; in response to a next state occurring, locally updating the activity patterns to create a localized activity pattern of the particular PUM; in response to the next state not matching at least one candidate next state of the candidate next states based on the localized activity pattern, generating an alert.

### CROSS-REFERENCES TO RELATED APPLICATIONS

The present disclosure claims benefit of U.S. Provisional Patent Application Ser. No. 63/569,458 titled “LOCALIZED MACHINE LEARNING FOR MONITORING WITH DATA PRIVACY”, which was filed on 2024 Mar. 25, and is incorporated herein in its entirety.

### BACKGROUND

Sensor-enabled environments may include one or more fixed location sensors, devices or systems installed in an environment or one or more mobile sensors, devices or systems that are present in the environment, all of which can be initialized, calibrated or configured for monitoring the health and wellness of one or more person under monitoring (PUM) in that environment. Data from a sensor-enabled environment may be processed to determine whether one or more behavioral, health, wellness, or safety events has occurred or is likely to occur.

### SUMMARY

Systems, methods, and apparatuses are provided for initialization, calibration or configuration of one or more machine learning systems or models for monitoring a sensor enabled environment (SEE) for health and wellness care management, including safety, for one or more persons under monitoring (PUM). In an example, a system comprises a plurality of sensors in an in-home or other environment in which the PUM is domiciled, a memory, and a processing device configured to receive current or historical data from the plurality of sensors, identify one or more patterns in the current or historical data from the plurality of sensors, and calibrate a previously trained machine learning model with the historical data from the plurality of sensors such that the machine learning model is operable to recognize departures from established patterns in the historical data.

In another example, a method comprises receiving historical data from a plurality of sensors, devices or systems identifying one or more patterns in the historical data from the plurality of sensors, devices or systems and calibrating a previously trained machine learning model with the historical data from the plurality of sensors, devices or systems such that the machine learning model is operable to recognize departures from established patterns in the historical data.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the Figures and the Detailed Description. Moreover, it should be noted that the language used in this specification has been principally selected for readability and instructional purposes, and not to limit the scope of the inventive subject matter.

### BRIEF DESCRIPTION OF THE DRAWINGS

The description will be more fully understood with reference to the following figures, which are presented as exemplary aspects of the disclosure and should not be construed as a complete recitation of the scope of the disclosure, wherein:

FIG. 1 illustrates a block diagram of an example system performing calibration of a sensor-enabled environment, according to example embodiments of the present disclosure.

FIG. 2 illustrates a block diagram of an example system performing calibration with digital twins of a sensor-enabled environment, according to example embodiments of the present disclosure.

FIG. 3 illustrates a data flow diagram for an example pattern calibration process, according to example embodiments of the present disclosure.

FIG. 4 illustrates an example embodiment of state management and watchdog functions, according to embodiments of the present disclosure.

FIG. 5 illustrates an example embodiment of calibration patterns and control states where a PUM and one or more stakeholders are present in a SEE which include one or more sensors, devices or systems for monitoring, according to embodiments of the present disclosure.

FIG. 6 is a flowchart for an example method, according to example embodiments of the present disclosure.

FIG. 7 is a flowchart of an example method for localized machine learning for monitoring with data privacy, according to embodiments of the present disclosure.

FIG. 8 is a flowchart of an example method for generating and maintaining a generalized AI/ML model from localized monitoring, according to embodiments of the present disclosure.

FIG. 9 illustrates an example computing device, as may be used as a controller in a SEE to monitor a PUM, as part of a sensor monitoring a PUM, as part of a central or distributed service providing calibration systems for generating and curating AI/ML models for distribution to the SEEs, and the like, according to embodiments of the present disclosure.

### DETAILED DESCRIPTION

Techniques are disclosed herein for initialization, calibration, or configuration of one or more machine learning systems or models for monitoring a sensor enabled environment (SEE) for health, wellness, and safety care management for one or more persons under monitoring (PUM). Monitoring of some individuals may be desirable for the health, wellbeing, or personal safety of those individuals. Monitoring may particularly be desirable for elderly individuals who may have limited memory, for example. Such monitoring, however, introduces significant concerns regarding privacy, handling of personal data, and overall quality of life.

Existing techniques for monitoring individuals for health reasons typically require than an individual relocate to a facility equipped with personnel and equipment specialized to perform such monitoring. Besides the obvious loss of freedom that this monitoring entails, monitoring for certain conditions can be quite invasive, and patient maltreatment can be a chronic problem for such facilities. Initially, one might think that constant monitoring of a person's home remotely to be a promising solution, which however, poses new challenges. Of notable concern is that of data privacy. Many individuals are rightly concerned about sharing their personal data with outside entities, particularly when that personal data includes sensitive information such as that which a sensor-enabled environment is capable of generating. Therefore, it is desirable to implement a monitoring solution to process sensor-enabled environment data without necessarily transmitting that data offsite, such that important information and alerts may be shared with a care provider, care hub or care processing systems without granting that care provider or systems unfettered access to one's personal life.

Systems and methods of the present disclosure achieve these and other benefits by training one or more machine learning models to recognize a variety of patterns in data that may be produced by a sensor-enabled environment. Such machine learning models may then be calibrated to a specific environment or individual by collecting reference data of the environment or individual, then further training the machine learning models to recognize patterns in the reference data as established. The machine learning models may proceed to monitor data from the sensor-enabled environment, and may identify or predict departures from the established patterns. The machine learning models may report these departures to a caregiver or to other care monitoring systems along with analysis such as a predicted cause of the one or more variations. Accordingly, monitoring can be provided in a localized context, where for example the PUM is domiciled. Since the machine learning model may be executed client-side at an individual's home and on an individual's one or more devices, techniques disclosed herein present the opportunity for individuals who require monitoring to have both privacy and security without the traditional value proposition associated with such monitoring. The lack of a need to transmit personal data also represents a significant advancement in security since data which is not transmitted cannot be intercepted, and data which is not handled by a human is less likely to be subject to careless or malevolent handling.

In some example embodiments of the present disclosure, sensors can be categorized as fixed or mobile. Fixed sensors may be embedded in an environment in fixed locations, for example attached to walls, floors ceilings or other surfaces within an environment. Mobile sensors may include those that are worn, carried or embedded within or on a PUM or other stakeholders, which includes but is not limited to: multi sensor devices, such as smart phones, smart watches, and fitness trackers, sensor enabled clothing, pendants, rings or other jewelry or accessories, and the like.

Initialized sensors may be integrated, using for example one or more care hubs, care processing systems or other integration systems to, at least in part, instantiate a Sensor Enabled Environment (SEE) for the monitoring of the health, well-being or safety of a PUM. When a sensor is installed or operated for the first time, the sensor or device in which the sensor is embedded undergoes an initialization process, which may at least in part establish one or more communication channels and set the parameters of the sensors to an initial value, which may include one or more self-test routines or other hardware or software watchdog processes. The initialization may include specifications of the sensors or device, including the type of measurements the sensor/device is capable of undertaking, including the type and units of measurements, and may include the accuracy or error rates of such measurements. The results of initialization may be communicated to one or more control or management systems, for example a care hub or care processing systems. These individual or aggregated specifications and measurements may be stored and managed by such a hub or process, and may include, for example, the physical parameters of an environment that, at least in part, comprises the SEE, such as the dimensions of the enclosed space.

In some example embodiments, there may be frameworks describing one or more movements, actions, activities, patterns or behaviors of a PUM in a SEE as described herein. These frameworks may, at least in part, comprise data sets of the one or more sensors of a SEE. For example, which can include initialized data sets from those sensors such that the framework with which one or more sensor has a relationship may be initialized with those data sets. Accordingly, the framework may be initialized into a default state.

In some example embodiments, the care hub, care processing systems or other managing systems may be initialized based at least in part on the specifications and data sets of the environment. In various embodiments, initialization may include physical dimensions of an environment, the specifications and placement locations of the one or more fixed sensors or devices, the positioning of the furnishings or objects that are part of the environment or the layout of the environment, for example represented by a map or an inclusion or manifest of one or more mobile sensors or devices.

These individual or aggregated measurements, including any specifications, may be normalized so as to initialize one or more physics engines that may be, at least in part, included or are integrated with one or more machine learning (ML) or artificial intelligence (AI) modules, including for example an LLM (large Language Model), LCM (Large Concept Model) or SLM (Small Language Model), and can include specialized AI/ML systems, such as for example an LLM or SLM that is configured to evaluate, for example, movement. For example, a neural physics engine may be configured with a set of measurements categorized by one or more types that may be aligned with one or more sensors or devices and the data sets that the sensors or devices generate. Such physics engines may include values, ratios, relationships or other measures and metrics that are compatible with deployed sensors, devices or systems measuring capabilities. Although generally referred to herein with respect to AI/ML, AI/ML systems, AI/ML models, AI/ML modules, or the like, the present disclosure contemplates that the reader will understand that any reference to “AI/ML” contemplate the inclusion of LLM systems, including specialized LLM or SLM customized for various purposes in such a system, model, module, or the like.

One potential example aspect of the initialization of the physics engine is validating the relationships between the one or more sensors, devices or systems and their measurement capabilities. As each sensor, device or system can have a certain measuring capability and the specifications of such sensors can be provided to a care hub, care processing system, or other data management system, these capabilities may be used, at least in part, to initialize one or more physics engines. In some embodiments there may be multiple physics engines deployed, for example, as modules, each of which may be specialized on certain physical aspects of the SEE being monitored, including the monitoring of the PUM therein. For example, a physics engine may be initialized to represent, in part or in whole, the PUM physical body.

In some embodiments, a physics engine may be coupled, directly or indirectly, to one or more AI/ML model to create, at least in part, one or more digital twins of an environment. Each of the sensors placed in that environment can be aligned to a physics engine such that the measurements and data sets generated by such sensors are normalized as inputs to that physics engine.

In some example embodiments one or more physics engines may be initialized to include environmental factors such as heat, light, airflow, humidity, carbon dioxide, and other atmospheric gases, presence of other chemicals, including ratios between such factors including gases, and may be employed to, at least in part, provide a comprehensive representation of the SEE.

A services monitoring system may be employed to, for example, monitor water, gas, electricity or waste usage within an SEE. The services monitoring system may include one or more AI/ML modules that, at least in part, measure, infer or calculate based on the flow rate of services, the use of such services by a PUM or other stakeholders in a SEE, which can include, for example, monitoring of waste products from the PUM or other stakeholders.

In some example embodiments an AI/ML system, including for example an LLM, may be deployed to, in whole or in part, for example, create a digital twin of the sensors or devices embedded in an SEE, including their specifications, initialization, state or data sets that these sensors generate in such an initialization state.

In some example embodiments, an AI/ML module, for example an LLM, may be employed for initialization of a set of sensors, particularly those sensors that share some resources such as those embedded in a device, those sharing a common power supply, those with common communications capabilities or those which are in close physical proximity to each other. For example, a sensor that uses active methods for sensing, for example millimeter radar or similar in smart light bulbs, may cause other passive sensors to measure incorrectly. The AI/ML, for example an LLM, module may, using specifications and other details of the environment, specifications of capabilities of the passive or active sensors, and capability for predicting the data sets such sensors can generate, which in some embodiments can include the use of LLM in collaboration with a RAG, can vary the initialization of such sensors to establish a comprehensive set of measurements of the SEE, where for example such interference of one sensors with another is mitigated or managed. which can include the use of vector bundles, clustering or other similar techniques to identify interference patterns for the one or more sensors, devices or systems.

In various embodiments, initialization may enable the SEE environment to be measured in one or more states, including an initial state of the SEE. The initial state can include a quiescent state where, for example, an environment is measured to establish an at rest state. These quiescent states may be, at least in part, configured, based on similar environments or situations, for example in an aged care facility. For example, the location of the sensors in such an environment may be the same in each room or set of rooms, and as such these sensors may then be initialized to measure the environment in which they are located.

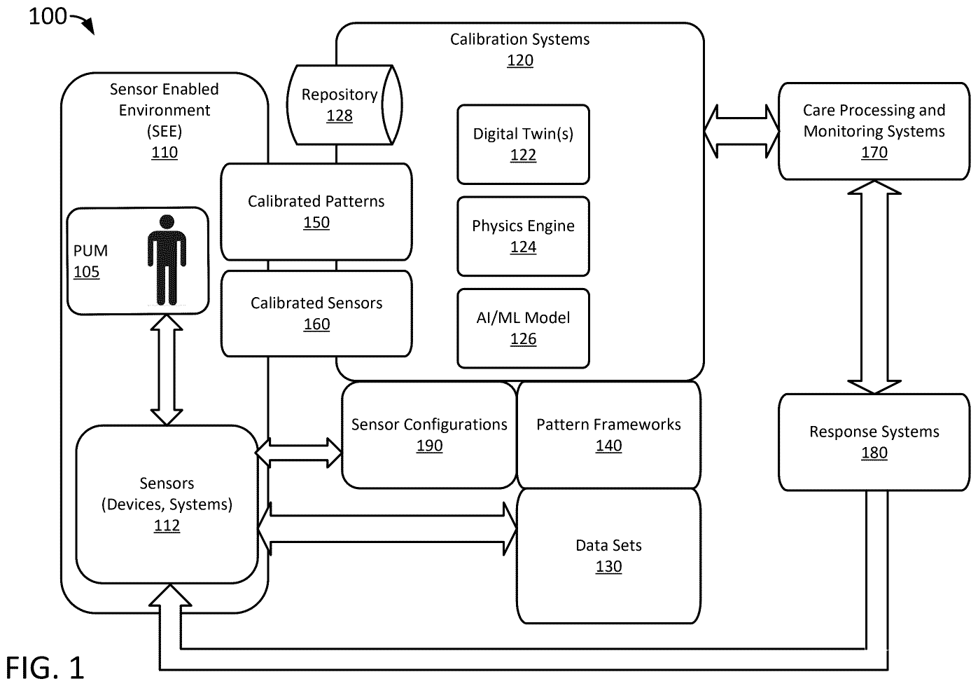

FIG. 1 illustrates a block diagram of an example system 100 performing calibration of a sensor-enabled environment, according to example embodiments of the present disclosure. The illustrated example includes a SEE 110 where a PUM 105 is monitored by one or more sensors, devices or systems 112. These sensors, devices or systems 112 may be initialized by one or more calibration system or processes 120. These initialization parameters may be stored in one or more repositories 128. The initialized one or more sensors, devices or systems 112 may generate data sets 130 or sensor configuration 190, which may then be aligned, by the calibration systems or processes 120 to one or more pattern frameworks 140. In various embodiments, alignment and calibration can include the use of one or more AI/ML Modules 126, Digital Twins 122, or physics engines 124. The calibration systems and processes 120 can then provide one or more calibrated patterns 150 or one or more calibrated sensors 160, including sets thereof for the monitoring of the PUM 105 in the SEE 110. The calibration processes and systems 120 can provide care processing and monitoring systems 170, including care hubs and care processing systems with further calibration data, which can result in communications to a response system 180, for example where such communication is an alert, which can be sent to sensors, devices or systems 112 to vary a configuration thereof.

Learning in an artificial neural networks-based machine learning system or other AI/ML, including LLM systems, including specialized LLM or SLMs, including for example LLMs, for example, may involve adjusting weights and other parameters, including multiple dimensions, such as for example multi-dimensional feature sets applied to every input and an output threshold of every network node in order to improve results of the overall output of the network. Approaches to learning in these systems are usually categorized as supervised, unsupervised and reinforcement learning. Each method is best suited to a particular set of applications.

In some embodiments a node in a model or neural net may correspond, in whole or in part, with a sensor, device or system that is capable of measuring the environment in which it is located and generating a data set representing those measurements.

Supervised machine learning methods may implement learning from data by providing relevant feedback. In various embodiments, feedback may be in the form of metadata including, for example, labels or class indicators that are assigned to input data sets, for example those generated by the one or more sensors, devices or systems of a SEE. For example, the metadata may include an image of a person on the floor with a “fall” label or a combination of acceleration, altitude, and inclination sensor dataset with a label of “walking” assigned to the image. Feedback may also be in the form of a function that maps input data to desired output values. The input data and the associated metadata or output mapping can be known as training data. The goal of supervised machine learning is to build models that generalize from the training data to new, larger, datasets.

Supervised machine learning is well suited for use in classification, which refers to predicting discrete responses from the input data. For example, whether sensor, device or system dataset or pattern represents a PUM's fall, a step or other movement-related state of a PUM, whether a sequence of sounds represents a PUM calling for help, or whether a combination of risk factors for the PUM should result in a call to an emergency medical service, carer or other third party.

Supervised machine learning may also be used on regression applications, where the system predicts continuous responses from input datasets. For example, in some example embodiments a supervised machine learning system may be used for estimating physical quantities such as room temperature, acting as a virtual sensor, device or system based on historical temperature data, which may be used, for example, to provide missing or contextual data from real sensors, devices or systems that stop working or communicating under some circumstances. A supervised learning approach may also be used in other embodiments to generate simulated sensor, device or system input to other sensor, device, system or care hub or care processing systems. For example, such synthetic data sets can be used for training of further ML/AI systems, including LLM or may form part of one or more digital twin.

In some example embodiments, selection and deployment of one or more patterns or sets thereof may be determined, at least in part, to simulate or model particular behaviors and ascertain predictive traits using machine learning in a directed manner. In various embodiments, selection and deployment may include the use of one or more frameworks for establishing outcomes based on determined variations of the sensor, device or system configurations. For example, there may be specifications for a degree of permissible variation in differing contexts for a given/desired/intended/predicted outcome (including sets thereof). In various embodiments, selection and deployment can include system derived pattern detections for outcomes that indicate compliance variations which are in whole or in part determined through the use of AI or machine learning techniques, including use of one or more LLM. For example, In various embodiments, selection and deployment could include the use of multiple LLMs, which act to in collaboration to determine an outcome, where for example an LLM evaluates the input data sets generated by the one or more sensors, devices or systems, the output of which may then be evaluates by a further system, for example a physics engine configured as a RAG, which then feeds a set of LLM each of which generates an output that is then summarized by a further LLM.

Unsupervised machine learning methods, on the other hand, may not require any labeled training data. Instead, they rely on the data itself to identify patterns and relationships. These methods are useful for identifying hidden patterns or intrinsic structures in the input data. Unsupervised machine learning is often used to cluster data points together, based on one or more common characteristics. For example, identifying pixels or other elements of an image that belong to an object or a person, in image recognition applications, or to find groups of sensors, device or system signals, or patterns, that are most likely to be present for a specific PUM situation. Clustering based on unsupervised machine learning systems may also be used in some embodiments to identify outliers. For example, when a sensor, device, or dataset pattern falls outside of a normal situation which in some cases may indicate an emergency or a faulty sensor.

In some embodiments, an LLM may be employed to operate on the data sets generated by the one or more sensors, devices or systems of the SEE, where these data sets, through the use of embedding are transformed to vectors by the LLM. Within the initial calibration or configuration of the one or more sensors, devices or systems of the SEE may, in whole or in part, inform the weights or other parameters used by the LLM in processing the data sets generated thereby. For example, the initial calibration and configuration may provide weights or other parameters that are representative of the quiescent state of the environment or the PUM. As the state of the environment or the PUM varies, for example as the PUM undertake their daily activities, the weights or other parameters that are assigned to the one or more data sets may vary in accordance with the changes in state of the environment. In various embodiments, the use of an LLM can include, for example, employing one or more modules or systems that, for example, include physics engines, movement evaluation systems, including for example an LLM configured for operating the data sets, one or more game theory modules that are configured to operate as a RAG for the LLM that is evaluating such data sets or further AI/ML, including LLM systems, including specialized LLM or SLM.

Machine learning-based clustering may also be used in some example embodiments to identify patterns within a SEE that can lead to a specific type of outcome. For example, such a system may be used to identify associations between different combinations of datasets representing sensor, device or system inputs, PUM's states, actions, events or environment states with desired outcomes (for example: a fall or another emergency is avoided, an emergency response happens on time.) or undesired outcomes (for example: an emergency situation occurs, resources to respond are not ready on time, notifications are not provided on time.).

In some embodiments one or more AI/ML modules, including for example one or more LLM, can be employed to predict the potential outcomes, including the risks, for a PUM. For example, predicting potential outcomes can include prediction of multiple potential outcomes, for example ranked by probability, with risk metrics for each. Such outcomes can be communicated to one or more care processing or care hubs for evaluation and potential responses.

In some example embodiments, classification of machine learning methods using reinforcement learning, which, as with supervised machine learning, uses feedback mechanisms, can be employed. In reinforcement learning, however, the feedback may be presented in the form of a general reward value for the generated output, instead of a set of the correct output dataset. The machine learning model may usually be trained with a series of trial-and-error repetitions until the machine learning model is able to resolve each case correctly. The presently described approach is useful for training systems to make decisions to achieve a desired goal or outcome in an uncertain environment. In some embodiments, the presently described machine learning method may be combined with one or more digital twins, where the digital twin is run multiple times and the machine learning system gets trained to generate the appropriate response, in the form of a decision dataset, for example a decision matrix, risk evaluation profile, state prediction or other single or multi-dimensional data set, to achieve the desired outcome for a PUM.

In some embodiments, the combination of machine learning and game theory may provide the identification and deployment of games that are representative of the characteristics and behaviors of a PUM or other stakeholders or other entities in environments, including those represented by one or more tokens. The use of machine learning and game theory can be particularly useful when monitoring, for example, for the detection of data inconsistencies, contradictory data sets, out of band data, or insider self-serving interests.

One aspect of the machine learning and game theory approach may be identifying real or potential unintended circumstances, behaviors, or outcomes, where, for example, reconciliation of the data sets provided by the one or more sensors, devices or systems and the machine learning generated data sets, both potentially represented by, or in one or more digital twins, may give rise to evaluations and reconciliations that identify such circumstances, behaviors, or outcomes.

One application of directed machine learning may be identification of derivations and construction of new patterns derived from sensor, device, or system data sets, such as those represented by operating and simulated digital twins and which match one or more characteristics of the context and PUM behavior variations.

When a SEE has been initialized, the SEE may be identified as being in such initial state. To effectively monitor the SEE and any PUM or other stakeholder therein, the SEE may be calibrated. In various embodiments, calibration may set sensors, devices or systems deployed within a SEE to a state, both individually and collectively, that can be used to monitor those stakeholders therein with sufficient fidelity, granularity, accuracy, or certainty such that the movements, patterns, behaviors, states, variations, or other characteristics of the PUM or other stakeholders may be determined in the context of their care, health, and wellness.

In various embodiments, calibration includes establishing a quiescent state of an environment, such that the “at rest” state of the SEE as whole may be used, at least in part, in any evaluations of any activities, changes, or variations within that SEE. Establishing the quiescent state of the SEE may support identification of any variances from that state. In some example embodiments one or more test procedures may be instigated as part of the calibration process. These test procedures may include but are not limited to active and passive elements such as noise generators, impact generators or color balance displays. For example, an initialized sensor set forming the initialized SEE, including the care hub, care processing and any other management systems, the one or more physics engines, and any AI/ML modules, including LLM's, creates a representation of the one or more data sets of the SEE, where each sensor set measures, at least in part, the SEE in a quiescent state, that is a state without PUM or other stakeholders present over a period of time, either contiguous or segmented, covering 24 hour clock time.

One aspect of the present disclosure includes, in some embodiments, the calibration of the SEE as a whole, creating a system for monitoring the PUM or any other stakeholders therein and their respective behaviors. Accordingly, in some embodiments, the state of the SEE and the representation of the activities of a PUM or other stakeholder (as measured by data sets, generated by the one or more sensors, devices or systems deployed or present within the SEE), can provide sufficient fidelity and granularity of the SEE state and the PUM or other stakeholder activities, that can support the identification, recognition or evaluation of the behaviors of the PUM or other stakeholders that form such activities.

For example, the dimensions and location of the fixed and movable objects in the environment may be mapped such that there is an initial layout and any changes in the environment layout may be identified and form part of the SEE data set. The mapping can include the preemptive adjustments to the movable objects in the environment to, for example, reduce risks to a PUM therein. Such movements can, in some embodiments, result in calibration or configuration sensors, of the one or more sensors, devices or systems present in a SEE.

In various embodiments, calibration includes the use of one or more AI/ML models, where, for example, the data sets of one or more sensors may be used to train the AI/ML models, to predict likely data sets, represented by for example, patterns, that match changes in a state of one or more sensors, devices or sensors. These predicted changes may then be used to evaluate data sets the one or more sensors, devices or sensors are generating from the SEE, for example using pattern matching.

These predictions may form part of one or more digital twins of all or part of the SEE, where interactions of the sensors, device or system sets based at least in part on the predicted data generated by the one or more AI/ML models may be evaluated in the context of the overall SEE to establish the relevant interactions, using one or more physics engines, for these data sets. Accordingly, the predicted data sets may be aligned with the physics of the SEE to create one or more predicted states of the environment, the PUM or combinations thereof. These predicted states may then be used, in whole or in part to configure the one or more sensors, devices or systems of the SEE.

One potential aspect of the purpose of the SEE may be the monitoring of one or more PUM who are domiciled within the SEE. For any PUM there are sets of movements, patterns, or behaviors that are repeated regularly, for example on a timed basis, such as daily, weekly, monthly or in smaller increments, such as hours, minutes, or seconds.

Many of these movements, patterns or behaviors may include basic physical existence functions, such as eating and sleeping, and a range of other repeated movements, patterns or behaviors that can include, for example, reading, exercise, or entertainment. These patterns can be defined in terms of data sets that one or more sensors, devices or systems within a SEE may generate, for example, sleeping may be identified as data sets where a PUM is in a horizontal position with a regular breathing pattern in a room designated or designed for sleeping, for example a bedroom with a bed, where other data sets can indicate lack of movement or no or reduced use of speech.

Data sets of these repeated patterns may form, in some example embodiments, pattern frameworks which may represent, for example, a 24 hour time period. For instance, there may be at least one sleep pattern framework, one or more eating pattern frameworks, or one or more hygiene pattern framework. These pattern frameworks may initially occur at differing times, which over a further period, for example a week, can provide further personalization of these frameworks to the particular behaviors of a PUM.

For example, alignment of these pattern frameworks to a specific PUM behavior may be used, in whole or in part, for the calibration of the one more sensors, devices or systems employed for monitoring. For example, in a sleep pattern, certain sensors such as smart light bulbs, mm radar or other active or passive sensors may be used to monitor the PUM in their designated or identified sleep room where the PUM is currently sleeping, whereas those in other rooms may be calibrated to detect movement that is not from the PUM.

These pattern frameworks and subsequent patterns, representing the sensed environment, may be used as part of the calibration of the SEE, represented as data sets that the one or more sensors, devices or systems generate. For example, an initial set of pattern frameworks may include sleeping, eating, waste, or hygiene, each aligned with 24 hour clock time for that PUM being monitored.

These pattern frameworks may, at least in part, be based, on a Health Care Profile (HCP) of the PUM under monitoring and consequently be adjusted to account for such factors as age, mobility, health, or wellness conditions. The alignment of the behaviors of a PUM, which can include those identified through monitoring or self-declaration, can be used in conjunction with a 24 hour clock framework to establish a PUM pattern framework comprising, at least in part, the activities and behaviors of the PUM during that 24 hour time cycle. In various embodiments, the pattern framework includes one or more contextual data sets, such as sleep patterns, exercise regimes, nutrition and eating patterns, socializing patterns, or entertainment patterns.

In some example embodiments, one or more SEE monitoring systems, including for example care hubs or care processing, are used to initialize and configure one or more physics engines, AI/ML modules including LLMs, one or more sensors, devices, or systems to instantiate one or more digital twins of these entities to generate data sets that are, at least in part, indicative of the patterns of a PUM, with a specified HCP in a particular SEE.

The use of 24 hour clock time pattern frameworks may be used to establish a broad granularity for the data sets generated by the one or more sensors in a SEE. For example, if the time is 2 am local (e.g., 0200), then there should not be any detected sunlight in most locales, and the PUM behavior is likely to be a sleep pattern. Each individual PUM will have their own sleep cycle, which may be aligned to the 24 hour clock time, for example a first PUM may sleep from 4 am to 11 am (e.g., 0400 to 1100), and a second PUM may sleep from 8 pm to 4 am (2000 to 0400).

For example, one or more monitoring systems for a SEE such as a care hub or care processing system may have an initial calibration set represented by a potential range of 24 hour clock times and one or more data sets that can be generated by the one or more sensors comprising the SEE.

In some example embodiments, these data sets may be categorized as pattern frameworks where the behaviors of the PUM in the SEE may be identified as, for example, including but not limited to: sleep set, exercise set, nap set, eating and meal set, waste set, body clean set, entertainment set, social set, reading set, writing set, communication set, regular medicine set, hobby set, work set, specialist activity set, health visit set, medical activity set, trip set, fall set, breathing impairment set, impact set, shopping set, visiting set, travel set, pharmaceutical side effects set, diminished mental acuity set, and physical dislocation set. It is important to note that example list is not meant to be limiting, and that these are merely some examples of pattern frameworks which may be employed by techniques of the present disclosure.

Each of these pattern frameworks may be represented by one or more data sets that may include the most likely 24 hour time period in which they are undertaken, a set of sensors, devices or systems that are capable of generating data for those patterns, sets of sensors, devices or systems that, although included in the SEE, are not capable of generating data that represents those patterns, and one or more data sets that may be generated by the undertaking of that pattern by the PUM.

Alignment of these pattern frameworks to behaviors of the PUM may be contextual in that, for example, a PUM may have a regular cup of coffee or tea in the morning, though at various differing times. A part of the calibration process may be identification of the pattern framework or pattern through the one or more sensors, devices or systems of the SEE where, for example, the process of coffee or tea making is recognized and times for the consumption pattern are recorded to give a range and distribution, including duration, of this pattern. The care monitoring systems may then identify if the PUM has changed their behavior, potentially indicating a behavioral, health, wellness, or safety event. In various embodiments, a pattern may be declared as a contextual time, that is where the clock time and duration may vary within, for example, one or more thresholds. Patterns can also be aligned with specific locations, for example, a kitchen for making the tea or coffee and, for example a sofa or chair for the consumption of such beverage. These locational attributes of the patterns, can, in some embodiments form part of the dimensions or parameters, as may any temporal data, of one or more AI/ML model. The action, activity, or events evidencing the behavior, however, may remain consistent as determined at least in part by the one or more sensors, devices or systems monitoring the SEE and the data sets generated thereby. Further examples of contextual time may include but are not limited to, for example, TV time, walk time, or reading time. Each of these contextual times may, in some example embodiments, be represented by one or more tokens.

In some example embodiments, when an initial set of 24 hour clock time pattern frameworks have been identified, calibrated, and configured, the pattern frameworks are instantiated as patterns and their data sets may then be used as a basis to determine a more granular set of patterns and data sets that are specific to an individual PUM. For example, in a sleep pattern, there may be finer granularity in determining when that sleep is REM sleep or involves snoring or other breathing patterns.

The refining of patterns based, for example, at least in part on the data sets of the sensors, devices, or systems of the SEE in conjunction with the 24 hour pattern framework or other correlated frameworks supports the personalization of those patterns to a specific PUM. Pattern refinement may enable one or more monitoring systems, such as care hubs or care processing systems, to evaluate these data sets for early identification of variances such as, for example, exceeding thresholds, parameterizations, or other metrics to at least in part identify behavioral, health, wellness, or safety events or impacts. Pattern refinement may be particularly important if those variations indicate, for example, a significant behavioral, health, wellness or safety event such as, but not limited to, a fall, movement difficulty or an indication that the PUM is changing behavioral patterns, for example, from a pattern that is quiescent to another pattern which is based on or includes one or more behavioral, health, wellness, or safety event such as a fall, movement difficulty or a breathing problem.

The patterns initially identified as 24 hour patterns may, in some example embodiments, have their data sets used, at least in part, to create a repository of such data sets for multiple PUMs, where the privacy of the PUM is ensured, for example, using encrypted tokens or other anonymization techniques. Accordingly, one or more AI/ML model may be invoked to evaluate the multiple data sets representing these patterns to identify commonalities or calibrations or configurations for the one or more sensors, devices or systems deployed or present in one or more SEE. The identification of 25 hour patterns may include the identification of additional sensing systems that may be applied to one or more sets of PUMs, for example those with a common wellness issue, such as emphysema.

For example, the data sets created may then be evaluated to create a set of features which are aligned with 24 hour time frameworks to create further frameworks with specific feature sets or dimensions, such as multi-dimension feature sets. For example, dimensions may include, but are not limited to: temperature, sunlight, humidity, audio, haptic, or video artifacts or any other data generated by the one or more sensors, devices or systems present in a SEE.

In some embodiments, patterns are formulated that are represented by one or more sensors data sets where, for example, those data sets are predicted based on PUM specifications including HCP and the specifications of the environment in which they are domiciled. The formulation of patterns may include the use of the one or more patterns describing the routine activities such as eating, sleeping, or hygiene where the data sets from the one or more sensors, devices or systems may be predicted with sufficient accuracy, using a combination of AI/ML modules, including one or more LLM and one or more physics engines.

One aspect of the calibration of a SEE is the alignment of the one or more physics engines with the environment or the PUM that is domiciled therein. For example, a physics engine may be initialized and configured to represent the space that is monitored by the SEE, which may include for example, the various physical characteristics of the environment, including the location, represented by one or more data sets.

In some example embodiments a physics engine may be configured to represent a PUM in whole or in part as evidenced by the one or more sensors, devices or systems of a SEE, including those that are embedded, carried or worn.

In some example embodiments, a physics engine may be configured with well-known rules of physics, including those of body dynamics, including a muscular/skeletal representation of a PUM, for example the ability of a body of a particular mass to move in a direction, for example, jump a specific height, the distance a particular body of a specific mass may cover in a specific time, or rates of flow of one or more sources of water, electricity, or gas or other physical properties, such as temperature, humidity, air flow and the like.

In some example embodiments, an AI/ML, including one or more LLM, may also be used to develop one or more models of the physics of a specific environment, which can be based, at least in part one or more physics engines. For example, if that environment is at an elevation (e.g. Mexico City), has a specific HVAC system, and is prone to earthquakes, the AI/ML may develop a model for a physics engine that is a representation of that environment.

In some example embodiments, one or more AI/ML module, including one or more LLM, can be configured to represent physics engines may take specifications of a SEE, specifications of one or more sensors, devices or systems in a SEE, specifications of the PUM HCP or specifications of 24 hour pattern frameworks to generate data sets that are likely to be representative of those patterns, which are then validated by a standard physics engine, including the using retrieval-augmented generation (RAG) techniques or multiple LLM, which can be configured as specialist LLM, for example a movement LLM.

A physics engine may be used as part of the AI/ML model training to provide a set of guard rails to ensure that the AI/ML does not generate models that are not subject to natural physical laws as well understood, which may include the use of AI/ML RAG techniques.

The combination of AI/ML, including LLM and physics engine(s) may be deployed in a number of configurations, which may include, but is not limited to, for example, developing a hypothesis of the data sets that may represent one or more patterns, augmenting, validating, or verifying the outputs of one or more AI/ML including LLM systems, such as in a RAG configuration, or using both AI/ML modules and Physics engines in various feedback or feedforward arrangements, which can include multiple instances of LLM, some of which may be configured for specialist operations.

In some example embodiments, one or more AI/ML model may develop a representative understanding of a specific environment that may have a higher granularity or fidelity than a standard physics engine may produce. For example, one or more sensors may be calibrated to an ambient temperature of an environment, including the annual variations and connected to one or more systems that provide weather data and forecasting such that a difference in temperature, where those differences may have a wellness impact on a PUM, and calibrations may be used to configure one or more physics engines which, for example, may be coupled with an AI/ML module to predict potential impacts on a PUM.

In some example embodiments, each of the patterns, represented as data sets generated by the one or more sensors, devices, or systems in a SEE, may be used to establish one or more baselines for quiescent behaviors of those patterns, which can be represented as control or baseline states. These data sets may be aligned to, for example, a 24 hour clock whereby the data sets generated by the one or more sensors, devices, or systems in the SEE may in totality and through one or more segmentations represent the one or more patterns and their states. Such data sets can be in the form of control data sets which establish a specific set of conditions for an environment or PUM, which in some embodiments may be communicated to one or more digital twin to provide a set of measurements from which deviations or variations, represented by further data sets from the one or more sensors, devices or systems may be evaluated, including by one or more LLM, or other AI/ML system, which can include development of one or more models by such LLM or AI/ML systems.

In some example embodiments, such data sets may be communicated to one or more digital twins where, for example, one or more physics engines configured to represent the SEE and one or more AI/ML, including LLM system configured to represent the one or more data sets representing the one or more patterns such as those of the 24 hour clock cycle, PUM behavior patterns, contextual patterns, or other patterns may be used to represent the SEE in part or in whole.

Accordingly, such digital twins may be used, in whole or in part, by one or more monitoring systems, for example a care hub or care processing system, to evaluate, compare, or match the data sets generated by the one or more sensors, devices, or systems of a SEE on a time, event, action, pattern, behavior, or other method. In various embodiment, the digital twin and the data sets thereof, can form, at least in part, training data for one or more LLM.

In some example embodiments, these pattern frameworks may have a state, for example one or more initialization, configuration, or calibration states, operating state, quiescent state, or event state. Such states can include those that are labeled as control states, for example where a PUM undertakes a consistent and repeated pattern, that can represent their behavior. In various embodiments, a control state can then be used, at least in part, to evaluate any deviations or variations, including the detection at the earliest possible time of any changes to the wellness, health or safety of the PUM, including the identification of any changes in the risk profile of such state, which in some embodiments can inform one or more weighting or other parameters that are employed by one or more LLM or other AI/ML systems.

In some example embodiments changes in state may be used in conjunction with one or more game theory modules. These modules may employ one or more AI/ML or LLM modules, digital twins, or physics engines to determine, at least in part, potential states that these pattern frameworks may have, including the strategies employed by the players of the game to change such states. In various embodiments, state change monitoring be applied to sensors, devices or systems, LLM, SLM, other AI/ML systems and any monitoring systems, including care hubs or care processing in any arrangement.

Such an approach may support identification of one or more patterns that may be unfolding in an SEE such that representations of the one or more digital twins may be compared to real time data from the sensors, devices, and or systems of the SEE so as to determine a best match and consequently identify a pattern that is operating at that time. Additionally, one or more digital twin may also support the identification of potential or actual transitions from one pattern to another.

The identification of such transitional behavior may include the use of one or more AI/ML systems, including LLM's, SLM's and or other ML/AI systems where the data sets of the patterns may be extrapolated by these AI/ML systems, including specialized LLM or SLM to identify potential new patterns that may be unfolding. In some embodiments, extrapolation may be further evaluated by one or more physics engines to ensure the AI/ML generated data sets are compliant with configurations of such physics engines. Further evaluation of these extrapolated data sets may be undertaken by the care hub or care processing systems where, for example, the behavior patterns of the PUM are represented, to align the AI/ML data sets with possible data sets for a PUM in an environment. These arrangements can include multiple LLM, SML, specialized LLM, for example movement LLM, AI/ML systems, physics engines or monitoring systems.

One aspect of the AI/ML or LLM, SLM or other specialized LLM modules is the evaluation, modelling, or determination or representation of a state of a SEE and the monitored PUM therein. Many of the patterns that a PUM undertakes have a quiescent state, that is to say that PUM behaviors within the context of that pattern are represented by a data set that aligns with their normal behaviors and as such are not of immediate concern for any health and wellness impacts, and such can be represented by one or more risk metrics or profiles. These states, represented by the data sets generated by the one or more sensors, devices, or systems in a SEE, may be used by one or more AI/ML model in conjunction with one or more digital twins to, at least in part, evaluate the potential impacts of any variations that have an underlying trend. For example, if an amount of sleep a PUM is having is reducing by a small amount each pattern, the AI/ML or LLM in conjunction with one or more digital twin may generate a forecast that there is a behavioral, health, wellness, or safety event that is likely to occur. In various embodiments, a forecast can include the adjustment of risk metrics and other dimensions of a multi-dimension feature set that can represent such data sets.

A state modeling and forecasting approach may be used for any of the pattern frameworks such that each of these pattern frameworks may have a data set that is representative of the quiescent state or control state of that pattern framework, which can support creation of a repository of such states comprising their respective data sets which may be used on a comparison basis to, at least in part, determine changes in state.

In some example embodiments, one or more AI/ML modules, including LLM, may be configured to operate as observers of data sets to identify variances in measured or observed data sets. Operating as observers may include but is not limited to evaluation of these data sets to ascertain accuracy, integrity, or reliability of the data sets. For example, one or more data sets generated by the sensors, devices, or systems may be evaluated to, at least in part, determine the sensor, device, or system accuracy or reliability. For example, if a light sensor is slowly deteriorating in a manner caused by a fault in the sensor, the AI/ML module that is observing such a sensor may generate an alert or other message which may be communicated to one or more care hubs, care processing, or other monitoring systems.

The calibration of AI/ML modules, including LLM and the parameters thereof may include communication to those modules of one or more training data sets, training modules, weightings, priorities, or other variables from one or more systems, such as care hubs or care processing systems. The calibration may include such training data that has, for example, been created by other AI/ML model that are monitoring other PUM in other SEE. These training sets may also be communicated from one or more digital twins employed to create such further AI/ML model calibration data sets.

In some example embodiments, one or more AI/ML model or one or more physics engines or one or more digital twins may be deployed by one or more watchdog systems, that can include one or more other AI/ML model. In various embodiments, a watchdog system can employ one or more physics engines, one more digital twins, one or more care hubs, one or more care processing systems, one or more sensors, one or more devices, or one or more systems, one or more control or baseline states for the identification, detection or remediation of the those systems, where the operations of these systems exceed one or more thresholds representing their accurate, reliable, authenticated, authorized or aligned operations. These deployed watchdog systems may be calibrated based on the data sets generated by the one or more AI/ML model physics engines, digital twins, care hubs, care processing systems, sensors, devices, or systems deployed in monitoring a PUM in a SEE.

In various embodiments, the watchdog function can use, for example, such techniques as sampling, continuous, statistical, threshold, exception, or other systematic methods to evaluate operating conditions of those systems. The watchdog systems may provide a heartbeat or other synchronous or asynchronous data set that may support the operating state of those systems.

As with other systems involved in a SEE, these AI/ML model physics engines, digital twins, care hubs, care processing systems, sensors, devices, or systems may be stateful; that is they have specific quantized states of operation. These states may be instantiated as part of the calibration processes where each of these states is aligned with the watchdog operations, for example using control or baseline states. The watchdog systems themselves may also have state and as such may undergo initialization, calibration, and configuration. In various embodiments, watchdog initialization may include assigning one or more watchdog functions to one or more systems in any arrangement.

In some embodiments, one or more LLM or specialized LLM or SLM may be configured as a watchdog to predict or identify sensors, devices or systems that are operating outside or at the limits of their calibration or configuration. Such an LLM or SLM may be used across one or more sensors, devices or systems, including sets thereof and may include interacting with specialist LLM, SLM or other AI/ML systems that are operating to detect specific PUM behaviors, such as those impacting the health, wellness or safety of the PUM, for example a fall, breathing problems, movement instability and the like.

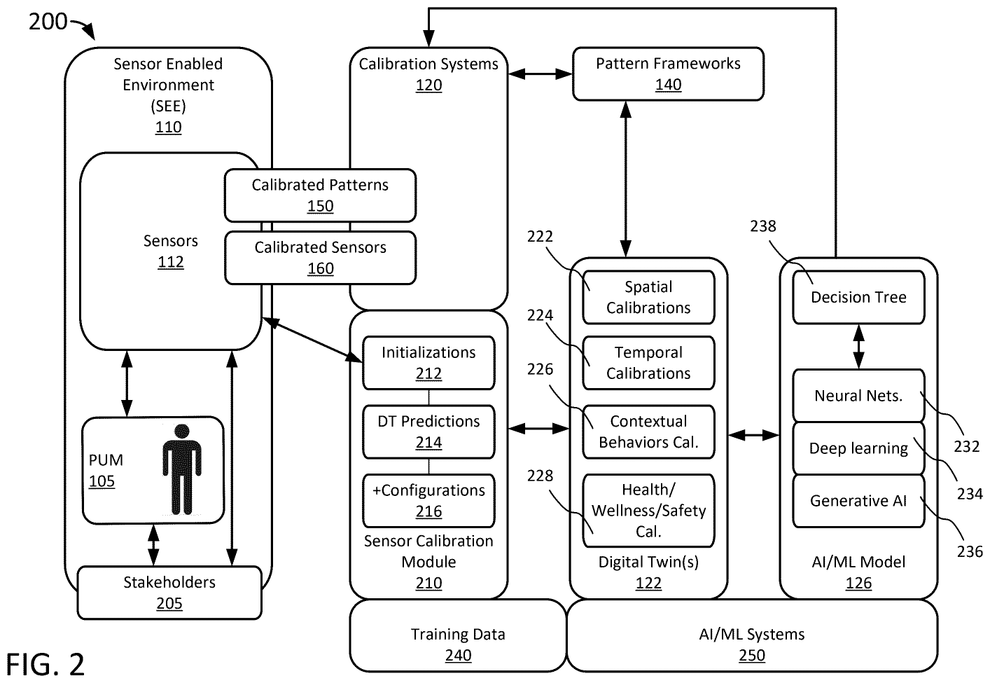

FIG. 2 illustrates a block diagram of an example system 200 performing calibration, with digital twins 122, of a sensor-enabled environment 110, according to example embodiments of the present disclosure. A SEE 110, in which a PUM 105 may be domiciled and interact with other stakeholders 205, may be monitored by one or more sensors 112. A calibration system 120, which may include one or more sensor calibration modules 210, may provide one or more initialization parameters or settings 212 for the one or more sensors 112. One or more digital twins 122 may be used in conjunction with one or more categorizations, for example, spatial calibrations 222, temporal calibrations 224, contextual behavior calibrations 226, or health and wellness calibrations 228, where such digital twins 122 and categorizations may be acted upon by one or more AI/ML modules 126 using, for example, neural nets 232, deep learning 234, generative AI 236, or other AI/ML methods and systems 250 which in conjunction with one or more decision tree 238 employing, for example, a decision matrix, create potential predictive calibrations or configurations. These digital twin predictions 214 may, in some example embodiments, be associated, incorporated, referenced, or embedded into one or more pattern frameworks 140 which in turn may inform or communicate with the calibration processes and systems 120. Predictions from the digital twins 122 may be used, in whole or in part, in initializations 212 of the sensors 112, and may be used as further configurations 216 which in some embodiments may be stored in one or more repositories. Sensor calibration modules 210, digital twins 122, or AI/ML predictive analytics may in whole or in part form training data for the one or more AI/ML Modules 126. The calibration processes and systems 120 using the elements illustrated herein may configure or generated one or more calibrated patterns 150 or one or more calibrated sensors 160, which may be aligned to monitoring operations for a PUM 105 in a SEE 110, and provide training data 240 in one or more data sets for later use and continuous improvement of the AI/ML systems.

In some example embodiments, SEE configurations may be aligned to one or more calibrated states of the SEE. For example, an initial quiescent state where the SEE has been initialized and calibrated becomes, in some example embodiments, an initial configuration of the SEE including the sensors, devices, or systems therein or involved in the monitoring of the SEE. This initial quiescent state represented by such configuration may be used to set a baseline, including one or more control or baseline states, for monitoring of one or more stakeholders therein, including the PUM, or any changes in the SEE environment. A baseline or control state may then be used to inform one or more LLMs, including for example an AI/ML model configured to represent such a control state, where the outputs of the LLM or SLM can be used, in part or in whole by other AI/ML model or further systems, such as personal physics engines or monitoring systems, such as care hubs or care processing.

In some example embodiments, one or more AI/ML model systems may be configured at least in part with specifications of a PUM including a HCP for the PUM and any representations of the PUM, for example a personal physics engine configured for that PUM and may include of one or more digital twins. In this manner the AI/ML model may use one or more digital twins and one or more behaviors such as tokenized behaviors of a PUM to instantiate configuration specifications for a SEE. These configurations may then be communicated to the SEE as behaviors of the PUM are observed. Accordingly, the configurations of the sensors, devices or systems of the SEE may be dynamically configured in anticipation of or in response to the behaviors of the PUM. Dynamic configuration can, for example, include the configurations being communicated to differing sensors, devices or systems, such that certain of the sensors, devices, or systems are configured for one type of behavior and others for another type of behavior. The behaviors resulting in dynamic configuration may be those output from the one or more AI/ML model where for example the anticipated behavior is one of a set of behaviors that are identified as likely to occur. Anticipation of behaviors can include, for example, the use of a game theory module to refine the outputs of such LLM or SLM where the data sets of the SEE are represented as the strategies in such game. These LLM or SLM outputs may also include or be evaluated by a personal physics engine, including those operating in one or more digital twin.

The AI/ML model may be configured with a set of initial behavior patterns, including behavior frameworks. The initial behavior patterns may comprise a set of typical behaviors for one or more PUM. For example, the typical behaviors may include but are not limited to breakfast, lunch, and dinner behaviors, exercise behaviors, entertainment behaviors, and sleeping behaviors. Some of these behaviors, such as sleeping and eating, are common to any PUM, although specific behaviors may vary according to locations, timing, and PUM preferences. The AI/ML model may use these initial typical behaviors represented in one or more digital twins to predict data sets that the sensors, devices, or systems of the SEE may generate for each of these behavior patterns.

The AI/ML model may then compare, at least in part or in conjunction with one or more other SEE management systems, such as for example a care hub or care processing system, to establish a relationship between the one or more predicted data sets represented in the one or more digital twins with real-time or near real-time data sets generated by the SEE sensors, devices, or systems. The comparison may enable the AI/ML model to, at least in part, identify the most likely candidates of these digital twin representations to align behavior patterns with actual behaviors of the PUM.

In some example embodiments, the AI/ML model potentially in collaboration or communication with one or more SEE management systems such as for example a care hub or care processing system, may communicate with the SEE sensors, devices, or systems in one or more configurations that, at least in part, support the AI/ML model care hub, care processing system, or other SEE management systems to more closely align the digital twin representations with the actual behaviors of a PUM. For example, one or more AI/ML models may operate on the data sets generated by the one or more sensors, devices or systems, and using one or more digital twin be configured to predict the future data sets such that these data sets become aligned. Accordingly, the digital twin may then have an AI/ML model that operates to vary such data sets, in light of potential PUM behaviors so as to generate a set of outputs of potential data sets that represent such behaviors.

In some example embodiments, one or more synthetic or virtual, sensors, devices or systems and physics engines may be used to, at least in part, evaluate the data sets of both sensors, devices or systems or physics engines, which may be included in a digital twin, for example. For example, a physics engine may be used to evaluate a data set from a sensor to ascertain a validity of that sensor data under current circumstances. The evaluation may include comparing sensor data sets with those of a digital twin of that sensor where the data sets have been generated by a physics engine configured for that environment. For example, if the sensor data states that the temperature is 100 degrees Celsius while the digital twin and physics engine combination may have a data set stating 25 degrees Celsius, an alert may be generated indicative of that sensor having a fault. The potential fault may include scenarios where a hot item such as a clothes iron or similar is placed near the sensor, and is not a fault but a potential cause for an alert.

The combination of sensor data and physics engines may also be used to generate data sets that are synthesized. For example, the combination of one or more sensors and one or more physics engines may synthesize data sets for humidity in an environment even though the sensors deployed are unable to directly measure humidity. In the same manner these combinations, including those using digital twins, may combine to generate new variables. In some embodiments the generation of new variables can include the use of one or more AI/ML models.

In an example, sensor data A derived from sensor A may be passed to a physics engine, which may use that data set to, at least in part, configure a digital twin, using for example an AI/ML model, for example including a digital twin generated by one or more AI/ML models, trained on sensor data sets to use the data set from sensor A to generate a further data set that may, at least in part, represent a further sensor data set. For example, data from a sensor B may be represented as data set B. In the same manner, the AI/ML model may generate a further data set that represents a change in a state of sensor A, for example, where the sensor measurements of the SEE differ from the initial measurements. These state changes may be propagated to other sensor data set representations, for example, sensor B, such that if sensor A and sensor B have a relationship such as colocation, the configured digital twin may represent these state changes, modulated by the physics engine to ensure that data representations are consistent with applicable physics of the environment or the PUM domiciled therein. Such an approach may enable a representation of a synthetic sensor, sensor C, to generate data set C, which may then be evaluated by installation of a (physical) sensor matching sensor C specifications.

A physics engine may be configured with one or more data sets that at least in part represent a SEE, including specifications of the environment to be monitored. These specifications may include, for example, location in terms of latitude/longitude, type of location (for example inner city/suburban and the like), relationship to roadways or other transit, dimensions of the environment, type of construction, types of wall and floor, number and types of windows, or alignment to magnetic north.

The configured physics engine may then be used, at least in part, to configure one or more digital twins representing the SEE. The digital twin (DT) may have a first state that represents the initialized state of the SEE. Digital twins may be configured to replicate the sensor measurements in an environment based at least in part on the specifications of the environment or the initialization specifications for the sensors as deployed in that environment. For example, the configuration may be based on the baseline or control state of the SEE. An AI/ML model may be instantiated and provided with one or more specification sets for one or more PUM domiciled in the environment. These specifications may include the HCP of the PUM including main or any secondary reasons for the monitoring.

An AI/ML model may generate a set of digital twins based on the physics engine data comprising at least in part data sets representing the environment. For example, temperature, humidity, light levels, noise and acoustic ephemera, vibrations, and other measurable artifacts of the environment may be included. An AI/ML model may receive and process new weightings or training sets for one or more sensors, devices, or systems deployed in one or more SEE for the monitoring of one or more PUM. The new weightings or training sets may include sets of sensors, devices, systems, AI/ML modules, LLM, SLM, LCM, or any deployed digital twins that are employed in the generation, interpretation, communication, or other processing of data sets generated in this manner. The data sets generated by the AI/ML models may include multiple differing behavioral, health, wellness, or safety events where configurations may be orthogonal.

The use of AI/ML model predicted data sets, in combination with one or more physics engines or one or more digital twins, may support continuous alignment of sensor configurations within the context of unfolding patterns representing, at least in part, behaviors of a PUM where such behaviors may be aligned, at least in part, on foreknowledge of PUM activities. These may include but are not limited to, for example, those represented by pattern frameworks, contextual behaviors, or other PUM previous behaviors represented by the one or more data sets generated by the worn, carried, or embedded sensors, devices, or systems including predictive data sets that form, at least in part, one or more sensor enabled environment.

In some example embodiments, an AI/ML model may be employed to use one or more digital twins to evaluate multiple sensor configuration options. These configurations may, for example, be evaluated for alignment with one or more behavioral, health, wellness, or safety events. For example, a digital twin may be configured to represent one or more sensors and their configurations for one or more event detections such as a fall, coughing, movement instability and the like.

These digital twins, in combination with one or more AI/ML models may be employed to iterate sensor configurations as a set where, for example, combinations of sensor configurations may be modelled in a digital twin. These configuration sets may then be deployed to sensor sets in response to changes in state of a PUM behavior, which can include the use of baseline or control states in the determination of such state change. An example of such a change might be a deterioration in PUM health conditions. These models may include, for example, combinations of sensor, device, or system configurations for predicted behaviors including but not limited to those represented by one or more AI/ML models, which may be used to vary configurations to represent differing quiescent parameters or the evaluations of the quiescent parameters.

Intra- and inter-sensor, device, or system calibrations may be undertaken to, at least in part, evaluate or establish relationships between sensors, including those of an environment such as temperature influence by sunlight or wind. These calibrations may be continuous, segmented, or quantized, in that the sensor data sets may be formed into groupings based on time, spatial metrics, contextual behaviors, or wellness and health considerations. These sensor relationship sets may be used at least in part by one or more AI/ML models as a training set, where techniques such as neural nets or adversarial leaning may be employed. These relationships may be dynamic or static, and can be persistent. In some example embodiments, these relationships may be stored in one or more repositories and may be used in SEE other than the SEE from which such relationships originated.

Correlations of measures or metrics may be established for the one or more sensors, devices, or system sets and sensors, devices, or systems thereof so that feature sets involving multiple dimensions may be determined. In some example embodiments, these feature sets may be focused on those environmental aspects that may have an effect on a PUM. In some example embodiments, there may be feature sets or dimensions that are contextual in that the feature sets or dimensions comprise data sets from multiple sensors, devices, or systems that in combination represent one or more temporal, spatial, behavioral, or wellness characteristics of the PUM in the SEE in which the PUM is domiciled.

In some example embodiments, an aspect of the alignment of the one or more sensors, devices, or systems and the grouping thereof may be the identification of data sets that are outliers in the context of the SEE and the sensors, devices, or systems in any arrangement. The identification of outliers may include alignment of the quiescent state of these sensors, devices, or systems data sets such that there may be a weighting for those data that are within, for example, the standard Brownian distributions, which may represent a predominant quiescent state of these data sets. One or more further weightings of those data not falling into such distributions may be employed where, for example, data outliers may be arranged by one or more classifications in form of dimensions such as in Markov models.

Relationships between these dimensions and standard distributions may be used in some example embodiments as training data for one or more AI/ML model or specialized versions thereof, including in one or more digital twins to evaluate and determine those dimensions and data sets that are indications of actual or potential behavioral, health, wellness, and safety events.

These interpretative calibration alignments, supported and at least in part enabled by one or more AI/ML models may enable these calibrated sensors, devices, or systems and data sets generated thereby to support predictive indications of changes of behaviors of a PUM or other stakeholders in relation to a wellness and health of the PUM. In some example embodiments, one or more feature sets of one or more dimensions from the data generated by the one or more sensors, devices, or systems employed in a SEE may be designated as a calibration function representing at least in part a specific feature or other characteristic of a SEE where a PUM is domiciled. For example, the calibration may include PUM behaviors which have known causations or correlations to a PUM health and wellness in a context of one or more condition. These calibration feature sets may be used, at least in part, to train one or more AI/ML modules, and may represent a prioritization of calibration of the sensors, devices, or systems comprising a SEE. In some example embodiments, such calibration features may, at least in part, be used to isolate one or more dimensions or feature sets from one or more sensor set data sets generated by the one or more sensors, devices, or systems in a SEE. These calibration feature sets may be correlated or aligned with the one or more PUM behaviors, including those specified in the HCP for associated PUMs.

In some example embodiments, one or more AI/ML models may be used to, at least in part, predict or inform deployments of the one or more sensors, devices, or systems within a SEE including those worn or carried by a PUM or other stakeholder. The informed deployments may include aggregation of these sensors, devices, or systems and their data sets, in part or in whole, into arrangements that may be used to represent calibration features, dimensions, feature sets, or any other combination in any arrangement.

In some example embodiments, the calibrated SEE, which includes the sensors, devices, or systems therein and the one or more systems monitoring such environment, may be dynamically aligned to the data sets generated by the SEE or the monitoring systems. The dynamic alignment may include the use of physics engines, AI/ML systems, or digital twins such that data sets that are generated by the sensors, devices, or systems and those generated by the one or more representations of those sensors, devices, or systems, such as those generated by one or more digital twins, including those operating with AI/ML model or physics engines, are evaluated by one or more further alignment systems that may be, at least in part, configured with specifications of the environment, PUM, or the behaviors for a PUM on a 24 hour clock basis, to ensure that the data sets being generated are consistent with those behaviors. The alignment may include evaluating such data sets to establish one or more thresholds that represent a potential or actual variance of those data sets from the monitored generated data sets. For example, alignment may support a determination of the sets of data that represent a change in the behavior of a PUM in a SEE.

The dynamic nature of evaluation, in that whatever sets of data are monitored may be evaluated by an alignment process to ensure representation of the data sets the SEE and the behaviors of the PUM therein, may be accurate and reliable, which may particularly be the case where AI/ML model is employed for prediction or other generative operations or where dynamic alignment systems operate as a watchdog function. Accordingly, if a generative module creates a data set that is not able to be represented by the PUM, environment, sensors, devices, or systems therein, the dynamic alignment systems may generate an alert, event, or other function, for example to ignore such generative data set.

One aspect of dynamic alignment may be development, through the AI/ML model of hypothesized patterns based at least in part on data sets generated by the one or more sensors, devices, or systems. These hypothesized patterns may be used for comparison with data sets of the SEE, often in conjunction with one or more physics engines. The hypothesized patterns may be used to form predictive patterns that in combination represent the one or more behaviors of a PUM or other stakeholders. In some example embodiments, such predictive analytics may be used to inform one or more response modules. The predictive analytics may be used, for example, employing one or more digital twins, such that a predicted pattern or behavior may be matched to one or more responses and the outcomes may be evaluated for impact, including risk assessment. The dynamic alignment may include the use of one or more physics engines to, at least in part, ensure the predicted pattern and the potential one or more responses are in alignment with the PUM, other stakeholders, or the SEE.

In some example embodiments, one or more digital twins may be used to simulate one or more behavioral, health, wellness, or safety events for a PUM in a SEE such as a fall, including of various degrees of intensity, and then compare multiple sensor configurations. One aspect of systems operations may be the use of dimensions in an evaluation of the one or more data sets generated by the one or more sensors, devices, or systems of a SEE. The use of digital twins to simulate behavioral, health, wellness, or safety events may include alignment of multiple dimensions, for example temperature, humidity, light, temperature, and other metrics. These alignments may form, in whole or in part, a configuration of the one or more physics engines employed.

In some example embodiments, dimensions may be created or generated as part of calibration of the one or more sensors, devices, or systems comprising a SEE for the monitoring of one or more PUM or other stakeholders. These dimensions may include those described as synthetic dimensions, where a combination of real dimensions, such as time, spatial metrics, sensor generated measurements or metrics, and other measurements or metrics may be combined to form a dimension that is specific to that particular PUM or a classification of types of a PUM. Generation of dimensions as part of calibration may be undertaken for other stakeholders as well, where those stakeholders such as a care provider may have contextual and other behaviors represented, at least in part, by one or more dimensions. In some embodiments, such dimensions may form part of a multi-dimensional feature set.

In some example embodiments, one or more digital twins may be calibrated based at least in part on data generated by a SEE or one or more AI/ML model using, at least in part, one or more models based on training set(s) created by the same or similar SEE data sets. These calibrated digital twins may then have a relationship with the SEE calibrated sensors, devices, or systems such that initially a digital twin may be calibrated identically, which in some embodiments, may represent the control or quiescent state, however over time or with one or more predicted events being instantiated by the AI/ML model there may be further alternative calibration data sets that may be used or stored.

Once a sensor set is initialized and forms part of a SEE, calibration of those sensors and the SEE as a whole may be undertaken. The calibration may include absolute and relative calibration where sets of sensors, devices, or systems may be calibrated relative to each other. For example, a first calibration may occur in isolation as an absolute. For example, a temperature measurement sensor may be calibrated to a known external temperature, providing an absolute calibration, which may undergo further calibration in relation to other sensors with which the temperature measurement sensor has proximity, such that heat generated by collocated sensors, devices, or systems can form part of the second calibration.

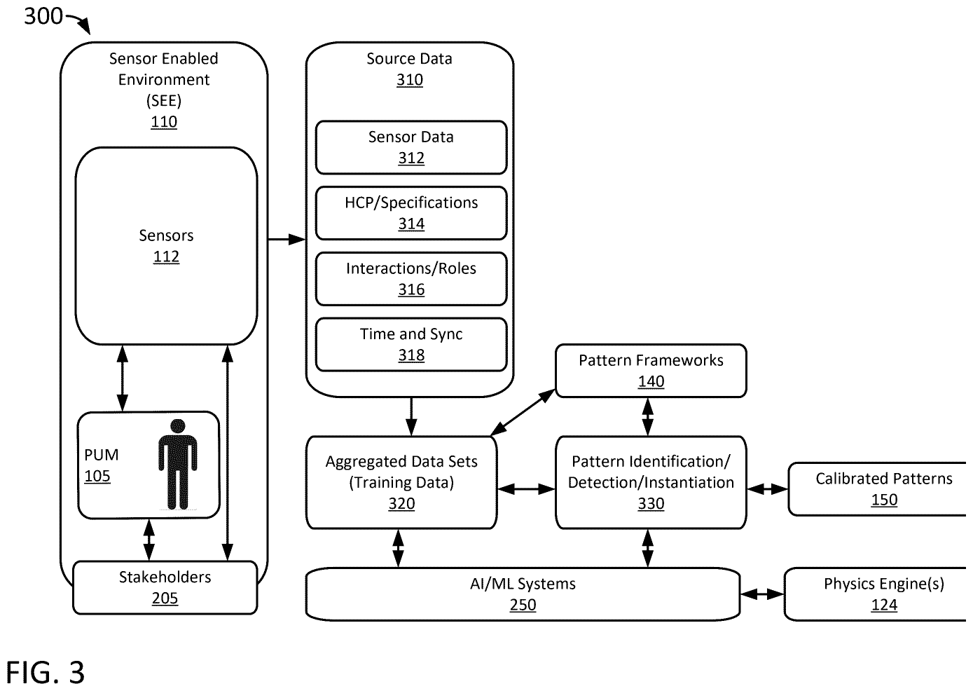

FIG. 3 illustrates a data flow diagram for an example pattern calibration process 300, according to example embodiments of the present disclosure. A SEE 110 may include one or more sensors 112, and have one or more PUMs 105 and other stakeholders 205 for the monitoring of the PUM 105 located therein. In the illustrated example, a set of source data 310, for example comprising sensor data 312, HCP or other specifications 314, interactions or roles 316 between and amongst PUM 105 and stakeholders 205, and time and synchronization data 318 are aggregated into data sets 320 which in some example embodiments may form training data for one or more ML/AI methods 250, where such methods may invoke one or more physics engines 124. The aggregated data sets 320 may undergo one or more pattern identification, detection, or instantiation processes 330 in conjunction with one or more pattern frameworks 140 to produce one or more calibrated patterns 150.

These calibrations may include the use of one or more digital twins or AI/ML models such that the ongoing performance of one or more sensor, device, or system may be incorporated into the calibration, potentially on a dynamic basis. In some example embodiments, the behaviors of the PUM or other stakeholders may initiate or influence these dynamic calibrations.

In some embodiments, one or more AI/ML systems may be employed to generate models that are indicative of the initial conditions of a SEE or a PUM or other stakeholder therein. The generation of models can include the use of digital twins or game theory systems that can operate in collaboration with the one or more AI/ML systems in a predictive manner that can, in some embodiments, configure or initiate preventative measures that are, in part or in whole based on the initial conditions, including state, of the SEE, PUM or another stakeholder. The generation of such models can include identification, detection or recognition of one or more patterns of the PUM or other stakeholder, where such patterns can indicate an increase in the potential or actual adverse events, including for example risk metrics of such activities, that can occur such that the AI/ML systems operate to invoke such preventive measures.

In some embodiments combinations of AI/ML systems, physics engines, game theory systems, digital twins, sensors, devices or systems can be employed in any arrangement to identify, classify or refine pattern detection or alignment.

In some example embodiments a specialized dashboard or control surface may be employed for alignment or calibration of a SEE or the one or more sensors, devices, or systems therein. One aspect of such a dashboard or control surface may be control of the use of one or more AI/ML modules to be employed or control the selection of training sets to be used. A similar dashboard or control surface may be employed for application of one or more game theory games or overall arrangement and integration of the one or more AI/ML model digital twins, physics engines, or game theory deployments.

In some example embodiments, calibration of a SEE may be undertaken on a spatial basis. For example, the SEE may be segmented into sections. A further aspect may be the use of a spatial segmentation approach to represent or predict a state of an environment or PUM in whole or in part. This may include establishing the state of an environment, including parts thereof, such as specific rooms or areas, where through initialization, calibration, or configuration, a section of the SEE is observed to establish a quiescent state for that section.

In some example embodiments, the SEE may be represented by a set of digital twins that have been configured to represent the state of the SEE. This includes where the SEE comprises a segmentation based on, for example, a physical layout of the SEE or a functional decomposition of the SEE. For example, in a multi room environment each room may have one or more states, whereas in a single environment, such as a studio space, each area, such as kitchen, bedroom, and living room may have one or more individual states, respectively.

In some example embodiments, a SEE may be segmented into sections or zones based, at least in part, on one or more physical characteristics including but not limited to location, dimensions, or physical data sets such as heat, light, or similar based on frequency, volume, or other metrics. Spatial segmentation may be used, at least in part, for configuration of one or more physics engines or AI/ML model in any arrangement. For example, sensors in a kitchen might ignore gas/stove heat spikes, oven induced temperature increases, and similar measurements that might trigger an alarm in a bedroom. In some example embodiments, the SEE may include one or more sensors, devices, or systems that monitor consumption of electricity, gas, or water in specific spatial areas of the SEE.

In some example embodiments, spatial segmentation may include PUM-centered spatial awareness. For example, if a PUM has a particular path between differing rooms in a house, around the garden of a house, or between rooms or facilities in an aged care facility, these may be evaluated using the one or more sensors, devices, and or systems in a corresponding SEE to identify any potential hazards for the PUM, including risk metrics.

In some example embodiments, pattern frameworks as described herein may be populated by data sets generated by the one or more sensors, devices, or systems operating within a SEE for monitoring a PUM. Using the pattern frameworks as a basis, temporal calibration may include arranging the 24 hour day of a SEE and a PUM domiciled therein into discrete segments comprising, at least in part, data sets generated by the SEE. These segments may overlap, in that a relationship to 24 hour clock time of the one or more segments represented by patterns may vary from a nominal initialization over, for example, a period of days or weeks. The sensors, devices, or systems of the SEE may be calibrated to, at least in part, generate data sets for the one or more temporal patterns so that those data sets may be identified.

For example, a camera aperture may be calibrated to available ambient light, such as when a PUM is sleeping. In some example embodiments, particular surfaces may have a specific color applied and the one or more image sensors may be calibrated to that color. This may enable detection of variances in, for example, a complexion of a PUM, or changes in an atmosphere of the environment caused, for example, by smoke. For example, an audio sensor may be calibrated to an amount of background noise such that the audio sensor generates data sets representative of the PUM in comparison to the ambient background noise. Each of the one or more sensors, devices, or systems may be calibrated, both individually and in arrangements such as sets, so that temporal conditions are represented by data sets generated by these sensors, devices, or systems.

In some example embodiments, the one or more sensors, devices, or systems of a SEE may generate sets of data that are representative of the contextual behaviors of a PUM including patterns that form such behaviors. This may include the use of pattern frameworks, such as those based on time, as well as those that are specific to a particular PUM. In some embodiments, these patterns can form calibrated patterns which are representative of the patterns or behaviors of the PUM formed by the data sets generated by the sensors, devices or systems of the SEE. The data sets generated by the SEE may be compared to data sets that form part of a behavior, represented in some example embodiments by a behavior token, herein described as a “Bevoken”. This Bevoken combines a set of patterns formed at least in part by a set of sensors, devices, or systems comprising a SEE.

One aspect of the deployment of AI/ML model for calibration may be the use of the one or more data sets generated by the one or more sensors, devices, or systems deployed in a SEE as a set of training data for the generation of for example patterns, which may include when the PUM is present or not present. The use of these data sets as a continuous or segmented training data set may support a continual training of the AI/ML model based on this data. The continual training can include the use of patterns, including calibrated patterns. In some example embodiments, the training data, being at least in part the data sets generated by the one or more sensors, devices, or systems deployed in a SEE, may be segmented, for example by time, and such segments may be stored in a repository and used, for example, in a digital twin where one or more AI/ML models may be employed to evaluate one or more patterns of the data therein. The evaluation by the AI/ML models may include the use of game theory to determine, at least in part, one or more strategies that may be deployed by the PUM, other stakeholders, or the sensors, devices, or systems deployed in the SEE. The segmented data may then benefit from the AI/ML model operating on the continuous training data such that the models generated by the AI/ML model using segmented data may be refined by the AI/ML model using the continuous data.

The use of these various data sets by the AI/ML system to create one or more models may be stored in one or more repositories such that a history of the generation, development, deployment, or use of these models may be retained. In some example embodiments a history of an AI/ML system use of a training data set and the model evolution developed during such training may be stored, in whole or in part. The historical data in the training data set can include the history of patterns, including calibration patterns that can be generated, for example, by those data and systems as illustrated in FIG. 3.

In-context learning is an emergent behavior of large language models (LLM), in which these LLM may seem to learn tasks given only a few examples. For example, the LLM may be given a prompt that consists of a list of input-output pairs that demonstrate a task, and then at the end of the prompt a test input is included. The LLM may make a correct prediction just by conditioning on the prompt and predicting the next tokens. To correctly complete the provided input with the correct output, the model may read “training” examples to calculate out an input distribution, output distribution, input-output mapping, or formatting.

For example, for the following input:

Jake Sullivan says U.S., Israel have agreed to ‘basic contours’ of a cease-
fire deal // Positive
Wildfires are killing California's ancient giants // Negative
How Portugal eased its opioid epidemic, while U.S. drug deaths
skyrocketed // Neutral
Consumers are pushing back against price increases - and winning //
Positive
Japan's moon lander survives a second weekslong lunar night, beating
predictions // Positive
Single-engine plane crashes at a small New Hampshire airport //

The popular LLM GPT-3.5 produces “Negative” as output using the first several labeled input and output for the final input of “Single-engine plane crashes at a small New Hampshire airport”.

In a similar manner, in some example embodiments, the AI/ML system may learn from patterns detected (for example behavior tokens, known as Bevokens) and dynamically adjust calibration according to pattern frameworks or Bevokens. This may lead to continuous learning by the AI/ML model of the behaviors of the PUM and calibration of the sensors, devices, or systems employed by or present in the SEE.

In some example embodiments, in-context learning may be used as a mechanism to “calibrate” interpretation of a data point or a dataset coming from one or more sensors, PUM's behavior, or other inputs in order to determine an occurrence of an event or the existence of a pattern or a behavior by providing the LLM with examples of input sets and resulting output for a particular PUM in a particular environment or at a particular state without a need to re-train the LLM for every case and PUM, which may be impractical.

One aspect of the tokenized approach may be creation of a repository comprising a compendium of calibrations that have been generated, at least in part, by the one or more AI/ML models. These calibrations of behaviors and patterns may form a training set for further AI/ML models, which may include a feedback mechanism, where a degree to which a model is an accurate representation of a set of sensors, devices, or systems and their data sets improves as the model represents specific behaviors of one or more PUM within one or more environments at one or more times. The calibration may include both known relationships or learned relationships for stakeholders, one or more SEE, or one or more PUM.

In some example embodiments these models, in whole or in part, may inform one or more calibration processes as to configurations, for example, with differing priorities or ranking adjusted to account for a predicted likelihood of a behavioral, health, wellness or safety event occurrence. For example, calibration may include having available a set of configurations for the SEE or elements thereof that may be dynamically applied to the one or more devices or sensors comprising the SEE. Calibration may include differing configurations for specific devices or device types such as worn or carried devices. These dynamic configurations may be based, at least in part, on the pattern frameworks, SEE data sets, patterns derived from AI/ML model or other criteria.

In some embodiments, the calibration processes, based at least in part on the one or models generated or employed by the one or more AI/ML models, can generate a set of calibration patterns which can be applied to the one or more sensors, devices or systems. For example, these calibration patterns can be communicated to one or more sensors, devices or systems in response to or anticipation of one or more behavioral, health, wellness, or safety events, alerts, risk metrics, threshold breaches or other triggers that have been generated by the one or more sensors, devices or systems of the SEE in response to the PUM activities. For example, if the PUM were to trip over a carpet or other floor based obstruction and for example a haptic sensor detected the footfall as they compensated, where such footfall was outside the threshold of such sensor, an alert can be generated that can invoke, for example a care monitoring system, for example care processing or care hub, to communicate a calibrated pattern to one or more sensors, devices or systems, for example including camera, microphone, worn or carried device, where the calibration is for the detection of a fall, misstep or other calibrated behavioral, health, wellness, or safety event, such that if the fall has occurred then one or more stakeholders may be alerted and if not then the other stakeholders may be informed in a manner that indicates immediate reaction is not required. The alert can include communication with the PUM, for example through a worn, carried or embedded device, for example one that includes a speaker to inquire as to the condition of the PUM.

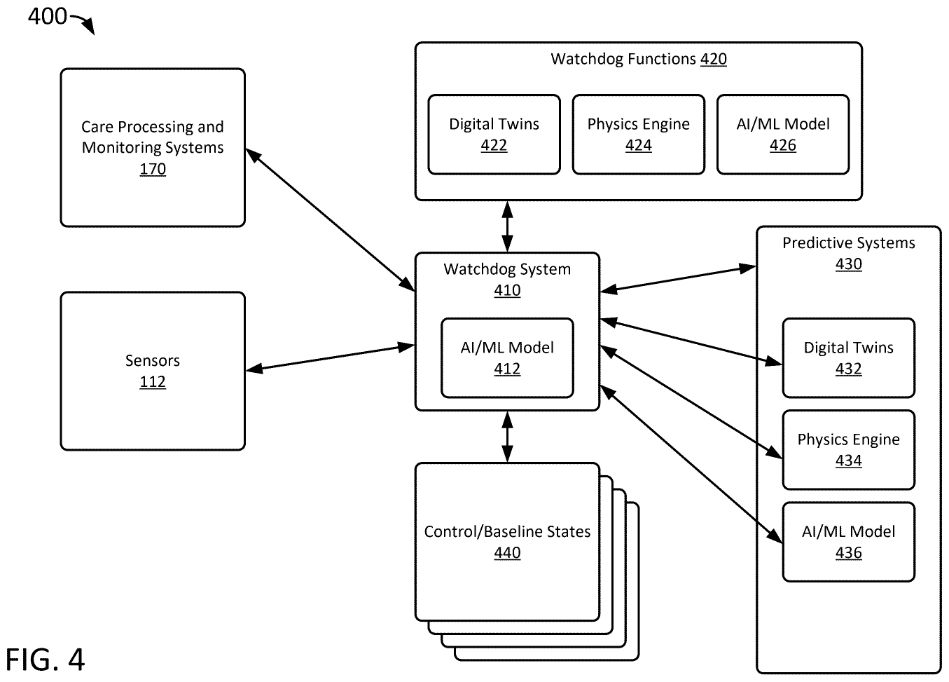

FIG. 4 illustrates an example embodiment of state management and watchdog functions 400, according to embodiments of the present disclosure. As illustrated in FIG. 4, a watchdog system 410 that includes an AI/ML module 412 (such as a specialized LLM/SLM) that monitors a set of other systems, including care processing and monitoring systems 170, Sensors, devices or systems 112 present in a SEE 110, and one or more predictive systems 430), including digital twins 432, physics engines 434, or AI/ML systems 436 (including LLM/SLM or specialized LLM/SLMs) in any arrangement. The watchdog system 410 can employ one or more watchdog functions 420, including but not limited to one or more digital twins 422, physics engines 424, or AI/ML systems 426, which may include specialized, for watchdog purposes, LLMs or SLMs. The watchdog system 410 may also employ one or more control or baselines states 440 as part of operations. In some embodiments, a watchdog system 410 can be bound to each of the one or more systems, such as described herein, and operate as a distributed network of watchdog nodes.

For example, in some embodiments, a SEE 110 can include passive or active sensors such as cameras and millimeter radar respectively, which are capable of detecting an adverse behavioral, health, wellness, or safety event such as a fall. In various embodiments, detection can include the use of one or more models generated by, for example one or more AI/ML systems, including LLM, SLM or specialized LLM or SLM. For example, a specialized SLM can be configured to, based on data sets provided by the one or more sensors, devices or systems, including for example one or more passive sensor such as a camera and one or more active sensor, such as millimeter radar, generate a model that can be used to identify, at least in part, that a specific adverse behaviorally, health, wellness, or safety event has occurred.

In various embodiments, such a specialized SLM may then provide one or more configurations to the one or more sensors, including both active or passive types, such that these sensors are configured to measure the condition of the PUM, such as for example the distress of the PUM at the situation, one or more vital signs, breathing or any other signs of the condition of the PUM. In some embodiments, the SLM may employ one or more calibrated patterns that are communicated to the one or more sensors, including where for example a set of calibrated patterns for differing situations are sent to separate sensors, devices or systems, such that a range of possible events can be monitored. For example, if a rapid change in vertical orientation is detected by, for example an accelerometer in a worn, carried or embedded device, then a set of calibrated patterns that have common pattern elements can be communicated to the differing relevant sensors, devices or systems.

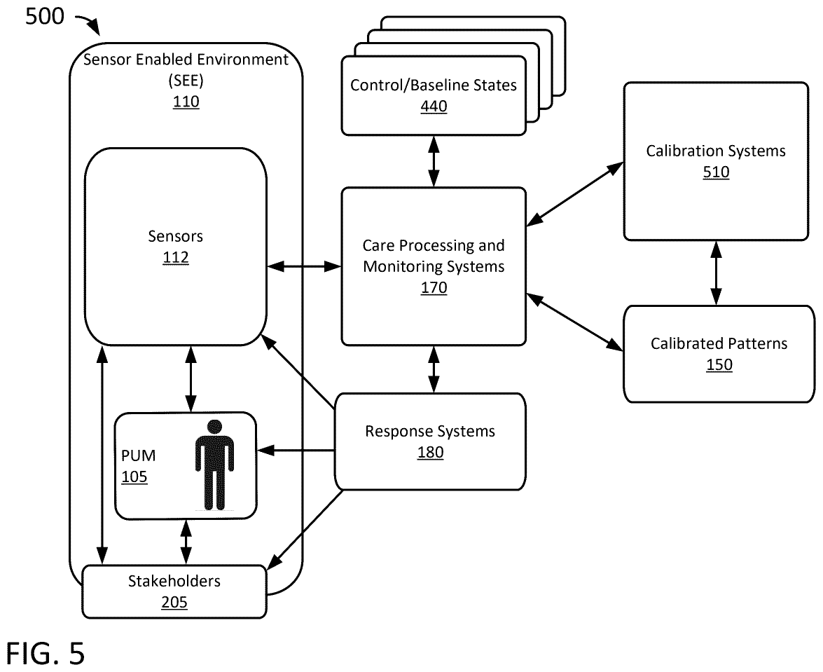

FIG. 5 illustrates an example embodiment of calibration patterns and control states 500 where a PUM 105 and one or more stakeholders 205 are present in a SEE 110 which include one or more sensors, devices or systems 112 for monitoring, according to embodiments of the present disclosure. One or more calibrated patterns 150 may be communicated, directly or indirectly, for example though one or more calibration systems 510, to one or more care processing and monitoring systems, including care processing or care hubs systems 170. Care processing and monitoring systems 170 can compare data sets generated by the one or more sensors, devices or systems 112 of the SEE 110, including alerts and events sent by the sensors 112 and other computing devices in the SEE 110 with the one or more control or baseline states 440 that represent, at least in part, the patterns and behaviors of the PUM 105, including quiescent states, and where appropriate communicate the one or more calibrated patterns (50 to the one or more sensors, devices or systems 112. The care processing and monitoring systems 170 can also communicate with the one or more response systems 180, that can interact with stakeholders 205, PUM 105 or sensors, devices or systems 112 in any arrangement.

In some example embodiments, training data may be continuous or segmented. The segmentation may be employed to separate differing spatial, temporal, behavioral, or health and wellness characteristics of the patterns or data generated by a SEE. In some example embodiments, calibration may include the use of generative adversarial network (GAN) to, at least in part, determine one or more configurations. In some example embodiments, the PUM HCP may include one or more health, wellness or safety conditions and symptoms of those conditions. The HCP may also include medicines that have been prescribed for such conditions, including the timing and frequency of their administering.

These health, wellness or safety topics may form part of the calibration of the one or more sensors, devices, or systems within a SEE where, for example, a set of sensors most useful for detecting these wellness topics may be initialized and calibrated to a specific PUM in a SEE. Using the health, wellness or safety topics in calibration may enable the appropriate sensor set and digital twins thereof to be calibrated to specific conditions of the wellness of a PUM. Accordingly, many of the idiosyncrasies of a specific PUM may be monitored or evaluated in a context of the PUM's particular condition(s). By monitoring specific conditions, the monitoring systems are able to more accurately evaluate PUM behaviors to, for example, reduce false positives and identify variations or changes more quickly, efficiently, and effectively with increased granularity or fidelity.

Part of a health, wellness or safety calibration may be the use of one or more, AI/ML models that include specialized LLM or SLM, which, for example, have been configured with respective medications for a PUM and the intents and side effects of those medications. The medication information enables the AI/ML models to identify, in part or in whole, characteristics of PUM behaviors in response to these medicines. The response behavior identification may include dynamic alignment of the one or more sensors, devices or systems involved in the monitoring of a PUM in an environment. For example, one or more calibration patterns may be communicated to the one or more sensors, devices or systems when an event or activity, for example PUM taking a medication, preparing a meal, taking a shower or bath, or any other activity that may be predicted or undertaken, such that these sensors, devices or systems are aligned to that activity for the earliest possible detection of any variations from, for example a control or baseline state, for example one representing the quiescent behavior of the PUM.

In some example embodiments, a PUM may have a HCP which includes specifications of the health conditions for which the PUM is being monitored. For example, the specifications in the HCP may be condition specific (such as emphysema) or general (such as reduced mobility or memory impairment). These PUM condition specifications may describe a predominant reason for monitoring and may include behaviors, events, activities, or other characteristics that are associated with those conditions. In some embodiments, one or more calibration patterns may be aligned with such conditions, so that the one or more sensors, devices or systems may be configured to be identify any impact on the wellness, health or safety of the PUM from those conditions at the earliest possible time. The alignment can include the configuration of the sensors, devices or systems to have the appropriate granularity, fidelity and other configuration parameters to enable this earliest possible detection.

The HCP specifications may include the PUM's pharmacological regime of prescription and non-prescription medicines or compounds that the PUM is ingesting, including, for example, any known side effects of those medicines or compounds and any known cross-medicant interactions. In some example embodiments, the calibration may include alignment of PUM behaviors with cross references of various medications or known specified side effects and interactions. In some example embodiments, one or more AI/ML models may be used, at least in part, to evaluate observed measurements and determine, at least in part, likelihoods that an observed behavior matches a known side effect behavior of one or a combination of medications. PUM specifications may include a HCP outlining a predominant reason for monitoring, which may include a condition and likely symptoms of that condition.

In some example embodiments, calibration may include determination of PUM behaviors that are likely to have an impact on the health, wellness or safety of the PUM, for example, medication side effects, falls, or breathing difficulties. The determination of PUM behaviors may, in some example embodiments, be undertaken by one or more AI/ML models in conjunction with one or more digital twins. The determination may involve, for example, using data sets generated by the one or more sensors, devices, or systems employed in monitoring a SEE. The use of one or more data sets may include such data sets from one or more repositories where, for example, data sets from other PUM or SEE that have been stripped of any identifying characteristics and potentially are encrypted as tokens may be provided to the one or more AI/ML model and digital twin systems for evaluation of likely behaviors that can have a health, wellness or safety impact.

In some example embodiments, the use of AI/ML models may include the use of one or more game theory modules, where an AI/ML model and digital twin combination may be used to extrapolate one or more game theory strategies to, at least in part, identify potential behaviors of the PUM expressed as data sets representing patterns or to rank those behavior sets into an ordered arrangement. The AI/ML model and digital twin arrangement and ranked behavior set may then be used to calibrate, for example using calibrated patterns, the one or more sensors, devices, or systems to monitor the PUM for ordered and predicted behaviors.

In some example embodiments, there may be one or more metrics and sets thereof for health, wellbeing or safety, including but not limited to metrics for the quality of life.

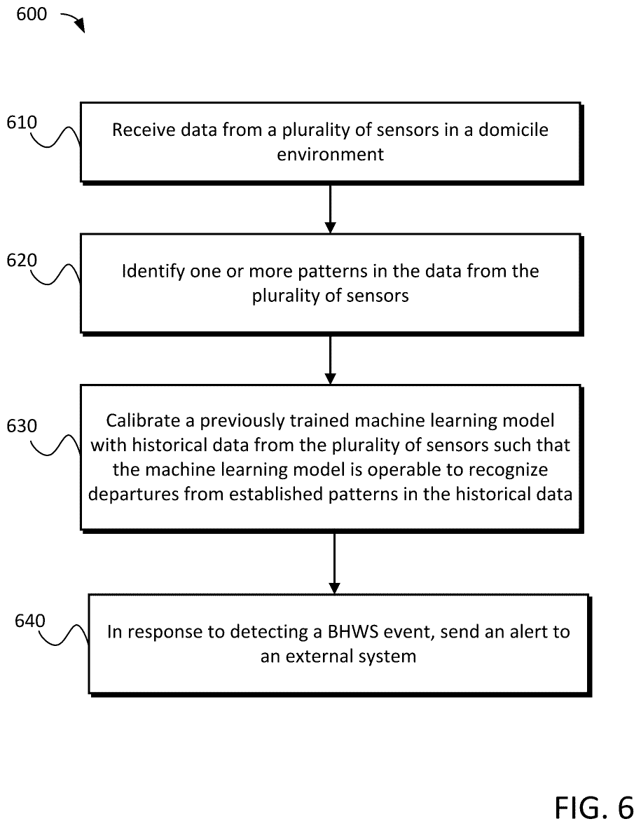

FIG. 6 is a flowchart for an example method 600, according to example embodiments of the present disclosure. It will be appreciated that the method 600 is for illustrative purposes only, is not intended to be limiting, and is presented with a high degree of generality for ease of understanding. It will therefore also be appreciated that described operations of the method 600 may themselves comprise several sub-operations, that some of the described operations of the method 600 may be excluded, that two or more of the described operations of method 600 may be performed substantially simultaneously or in a different order than described herein, and that additional operations not illustrated may be included in actual embodiments of the method 600.

At block 610, an example processing device receives historical data from a plurality of sensors in a domicile environment. For example, a device executing a monitoring program for a sensor-enabled environment (SEE) may receive data from one or more thermometers, motion sensors, cameras, microphones, flow meters, smoke detectors, carbon monoxide detectors, light sensors, waste analyzers, scales, mobile devices, medical instruments, or other sensors.

At block 620, an example classifier identifies one or more patterns in the historical data from the plurality of sensors. For example, a machine learning model running on the device executing the monitoring program may detect one or more trends in the data, then segment or tag the data to identify one or more correlations between data from different sensors along with likely causes of each correlation (e.g., increased heat and motion in a kitchen corresponding to a PUM using a stove or oven).

At block 630, an example calibration module calibrates a previously trained machine learning model with historical data from the plurality of sensors such that the machine learning model is operable to recognize departures from established patterns in the historical data. For example, a machine learning model which has previously been trained on data from monitoring individuals with dementia may be copied to the device executing the monitoring program. Data from a particular PUM's environment may be provided to a supervised, semi-supervised, or unsupervised training program which may further train the machine learning model with the quiescent historical data collected at block 610 such that the machine learning model is able to recognize when the PUM is experiencing a dementia event.

At block 640, in response to detecting a behavioral, health, wellness, or safety (BHWS) event, the machine learning sends an alert to an external system. For example, when a health event, such as a dementia flare-up, is detected, the machine learning model can send an alert to a stakeholder of a caregiver, so that the caregiver is made aware of the dementia flare-up. The present disclosure contemplates that a BHWS can describe various incidents that may be classified as one or more than one of a behavioral incident, a health incident, a wellness incident, or a safety incident for various PUM, and may be determined by interactions among several such incidents or events to describe an emergent event. Additionally, BHWS incidents may include both “positive” and “negative” incidents, or incidents that be characterized in multiple ways or as multiple ones of behavioral incidents, health incidents, wellness incidents, or safety incidents. For example, a dementia flare-up may be classified as both a health event and a behavioral event, and may include several other BHWS events that, when combined, describe the BHWS event as a dementia flare-up event in addition to or instead of as the individual events thereof. Additionally or alternatively, as an inverse to a dementia flare-up event, a lucidity-break (e.g., a positive vs. negative event) may be monitored and alerted for using the same or different sensors and the same or different alerting conditions.

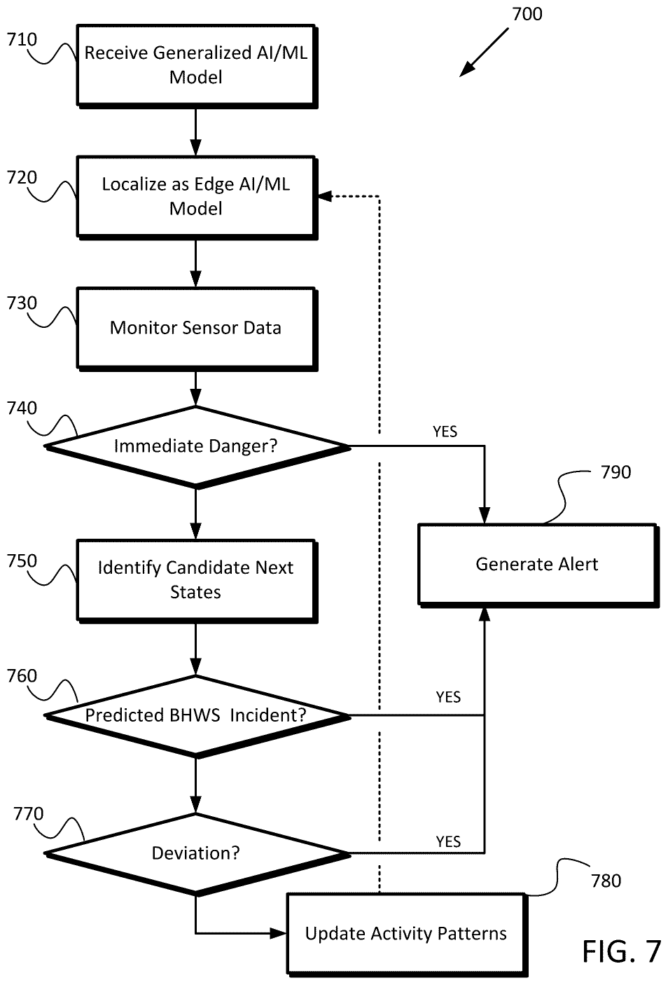

FIG. 7 is a flowchart of an example method 700 for localized machine learning for monitoring with data privacy, according to embodiments of the present disclosure. Method 700 begins at block 710, where a computing device associated with a (local) SEE receives a generalized artificial intelligence or machine learning (AI/ML) model for monitoring a person under monitoring (PUM) in a sensor enabled environment (SEE), the generalized AI/ML model including generalized sensor setting and generalized activity patterns for monitoring a generalized PUM in a generalized SEE.

In various embodiments, the generalized AI/ML model is one of a plurality of generalized AI/ML models held in a repository by the central service, for example a care processing service or care hub, which can be provided to different SEEs based on the local conditions of the SEE or the intended PUM. For example, the repository stores a first AI/ML model for SEEs that include multiple monitored zones or rooms, and a second AI/ML model for SEEs that include a single monitored zone or room, etc. to account for different layouts and sizes of SEEs. In an example, the repository stores a first AI/ML model for PUMs that have an HCP related to a first medical condition, a second AI/ML model for PUMs that have an HCP related to a second medical condition, a third AI/ML model for PUMs that have an HCP related to the first and the second medical condition, etc. to account for different monitoring needs. In an example, the repository stores a first AI/ML model for PUMs that live alone, a second AI/ML model for SEEs that house multiple PUMs with one another, a third AI/ML model for PUMs that live with non-PUM persons (e.g., stakeholders, caretakers), a fourth AI/ML model for PUMs that live with animals (e.g., pets, service animals), and various combinations thereof to account for different effects of non-environmental actors on the PUM and SEE (which may be modeled by one or more digital twins in addition to digital twins associated with the PUM(s)). In an example, the repository stores a first AI/ML model for SEEs located in a first geographic region, a second AI/ML model for SEEs located in a second geographic region, etc. to account for different weather patterns, legal frameworks, day lengths, etc.

At block 720, the computing device localizes the generalized AI/ML model as an edge AI/ML model. In various embodiments, localization includes at least one of: calibrating the generalized sensor settings within the generalized AI/ML model based on sensors within the SEE, physical characteristics of the SEE, and a health care plan (HCP) for the PUM; and calibrating the generalized activity patterns within the generalized AI/ML model based on the sensors within the SEE, the physical characteristics of the SEE, and the health care plan (HCP) for the PUM.

In various embodiments, the localization can be initialized at a central service, and continues on a local computing device associated with the SEE. In some embodiments, a local computing device associated with the SEE receives the generalized AI/ML model and performs substantially all of the localization actions. In some embodiments, a central service localizes (or performs substantially all of an initial localization) on behalf of the SEE, and the local computing device associated with the SEE receives the edge AI/ML model from the central service.

In various embodiments, localization can include one or more of spatial calibrations, temporal calibrations, or behavioral/health/wellness and/or safety calibrations. These localizations can include selecting initial patterns frameworks based on the spatial, temporal, or HCP data received related to the PUM or SEE, adjusting pattern frameworks based on the spatial, temporal, or HCP data received related to the PUM or SEE, learned information from monitoring the PUM and SEE, and combinations thereof.

For example, a spatial calibration can include identifying where the SEE is located geographically, how large the SEE is, how different regions within the SEE are organized, and combinations thereof to affect how and what alerting conditions are monitored for the PUM. For example, a generalized pattern framework can identify when certain behaviors result in an alert based on external temperatures so that opening a window when the weather is below, for example, 5 degrees Celsius or above, for example, 35 degree Celsius may result in generating an alert while opening the window between those temperatures does not. Accordingly, the AI/ML model can be spatially calibrated to take into consider local weather conditions while monitoring the PUM. Similarly, geographically relevant sunrise/sunset data (which may also be considered in temporal calibrations) can be included in spatial calibrations, as can pollen or air quality measures, precipitation, or the like.

In some examples, spatial calibration includes a layout of the SEE, so that a generalized behavior pattern of performing various sequential activities can be matched to the sensors at the relevant locations within the SEE. Accordingly, a behavior pattern data from sensors in a bedroom, an intervening hallway, and a kitchen are identified for monitoring a first PUM when performing a behavior of waking and walking to a kitchen in a first SEE, but that same behavior pattern can be matched to different sensors in different locations for a second PUM in a second SEE who travels from a bedroom directly to a front door (e.g., to collect a morning paper) and then a hallway to a kitchen.

For example, the dimensions and location of the fixed and movable objects in the environment may be mapped such that there is an initial layout and any changes in the environment layout may be identified and form part of the SEE data set as part of a spatial calibration. The mapping can include the preemptive adjustments to the movable objects in the environment to, for example, reduce risks to a PUM therein. Such movements can, in some embodiments, result in calibration or configuration sensors, of the one or more sensors, devices or systems present in a SEE.

In various embodiments, a temporal calibration can include identifying various absolute and relative times in which behaviors are expected to be performed. These calibrations can include adjusting the order of performance of individual behaviors within a pattern, durations of various behaviors within a pattern, a rigidity of adherence to a pattern (e.g., how concerning a deviation from a pattern should be treated), when a particular pattern/behavior occurs relative to absolute time (e.g., as indicated by a master clock), when a particular pattern/behavior occurs relative to another pattern/behavior, and combinations thereof.

For example, a general behavior pattern can indicate that the general PUM is expected to sleep between 7-9 hours any particular night, and that the duration of sleep is expected to occur in a time period between 9 pm and 9 am. However, local calibration of a sleep behavior can include that sleep should be expected to be divided into several shorter segments with visits to a bathroom therebetween, should last longer or shorter than the initial 7-9 hours, should occur for a different range of time, or should occur in a different time period, and combinations thereof. These local temporal calibrations can be based on PUM preferences or learned behaviors, and can also be affected by data included in an HCP. For example, when monitoring a first PUM for narcolepsy, sleep behavior outside of a prescribed absolute time period may be treated as an alerting condition, whereas a second PUM (not being observed for narcolepsy) taking a nap outside of a prescribed absolute time period may not be treated as an alerting condition on its own.

In various embodiments, a behavioral/health/wellness or safety calibration can include identifying various behavioral patterns or health conditions to monitor for, and how to monitor for those behavioral patterns or health conditions according to data indicated in the HCP, available sensors in the SEE, and PUM preferences, among other inputs. These calibrations can include adjusting alerting thresholds for immediate danger conditions, typical/atypical behavior patterns, and combinations thereof. For example, behavioral/health calibration can include identifying a heart rate sensor associated with a first PUM and monitoring the first PUM for heart arrhythmias according to the HCP, while behavioral/health calibration for a second PUM can include identifying a heart rate sensor associated with the second PUM and monitoring the second PUM for tachycardia according to the HCP (e.g., a different health condition using the same sensor).

For example, behavioral/health calibration for PUMs monitored for tachycardia may include ignoring, dampening, heightening tachycardia determinations based on recognized behavior patterns for the PUM and the expected (potentially beneficial) elevation of heart rate when so engaged. Accordingly, calibration can identify that when a PUM engages in day-to-day activities not associated with elevated heart rates, a first heart rate threshold should be used to detect negative tachycardia health events. This first threshold may be based on a resting heart rate specified in the HCP for a particular PUM, and may be adjusted based on observed heart rates and other health data included in the HCP or learned over time. Continuing the example, behavioral/health calibration can identify that when a PUM engages in various activities associated with elevated heart rates, such as rigorous exercise, a second heart rate threshold, greater than the first heart rate threshold, should be used to detect negative tachycardia health events (e.g., avoiding false positives). Similarly, behavioral/health calibration can identify that when a PUM engages in various activities associated with decreased heart rates, such as napping or watching television, a second heart rate threshold, less than the first heart rate threshold, should be used to detect negative tachycardia health events (e.g., avoiding false negatives, increasing early detection, etc.).

The present disclosure contemplates that the identified behaviors for individual PUM can be learned to further adjust the behavioral/health calibrations over time. For example, various activities for a first PUM may be identified as relaxing while identified for a second PUM as exciting (e.g., associated with nominally higher or lower heart rates, blood pressures, etc.) so that the thresholds and other monitoring criteria are locally calibrated accordingly.

At block 730, the computing device monitors sensor data from the sensors to monitor the particular PUM within the particular SEE. Monitoring the sensor data allows the computing device to locally identify a current state of the particular PUM and the particular SEE. The sensor data may be received directly from various sensors disposed throughout the SEE, but may also include various synthetic data sets for information about the SEE or the PUM that are not directly measured by any one sensor, but are synthesized from the data provided by two or more sensors. For example, when temperature data are provided by a first sensor in a first zone and a second sensor in a second zone, temperature data can be synthesized for a third zone (not associated with a temperature sensor) using actual data from the first sensor and the second sensor and knowledge regarding the layout and heating patterns of the SEE. In an example, the combination of one or more sensors and one or more physics engines or digital twins may synthesize data sets for humidity in an environment even though the physical sensors deployed are unable to directly measure humidity.

At block 740, the computing device, for example, via a watch dog system or routine, determines whether the current state of the PUM and the particular SEE indicates an immediate danger state. In various embodiments, an immediate danger state is identified based on a current state of the PUM or SEE being associated with a currently detected condition identified with an alert condition. When an immediate danger state is detected, method 700 proceeds to block 790, but may continue monitoring the PUM and perform additional operations of method 700.

In various embodiments, the alert condition may be present in the generalized AI/ML model and the localized edge AI/ML model, only in the localized edge AI/ML model (e.g., added to the generalized AI/ML model), or only in the generalized AI/ML model (e.g., removed from the localized edge AI/ML model). For example, temperature of over X degrees Fahrenheit in the SEE may be generally present to indicate a fire in the SEE, which, when detected, is classified as an immediate danger state that causes an alert to be generated. In an example, detection of an open window may be classified as an immediate danger state for a PUM with dementia (e.g., for an increased risk of exit from the SEE) in an edge AI/ML model localized for such a PUM, but not for a general PUM. In an example, detection of a general PUM on the floor of the SEE for at least X minutes may generally be classified as an immediate danger state (e.g., indicative of a fall or other BHWS event), but a localized edge AI/ML model may ignore such data as not indicative of an immediate danger state or not detect such a state as an immediate danger state for at least Y minutes (where Y>X) or until supplemented by another sensor reading for a particular PUM who is identified engaging in activities that occur while lying on the floor (e.g., yoga, stretching, prescribed/preferred time lying on a hard surface, etc.).

At block 750, the edge AI/ML model identifies a plurality of candidate next states for the particular PUM and the particular SEE for which the edge AI/ML model is localized and using sensor data based on the current state or the activity patterns of the PUM. In various embodiments, the edge AI/ML model identifies the current state of the particular PUM and the particular SEE based on sensor data, and identifies one or more digital twins of the PUM, the SEE, or other entities in the SEE to simulate what the twinned entity will do next.

In various embodiments, each digital twin incorporates specifications of the capabilities of the entity that the digital twin is associated with. Each digital twin incorporates the physical characteristics of the entity and represents the state of the entity within a simulation of the environment. The interactions between digital twins provide an accurate and timely predictive representation of the interactions between the entities, which can be used to generate candidate next states over a plurality of iterations, where more-likely candidate next states are simulated more often than less-likely candidate next states.

In various embodiments, digital twins can represent the care and wellness state of a PUM and the environment with sufficient fidelity so as to be used in predictive analytics, including the use of machine learning, for the care and wellness benefit of the PUM. In many circumstances the digital twin can be one of a set of digital twins representing a set of PUM that have a common set of care and wellness characteristics, such as the same or similar HCP and the operating patterns and pattern elements thereof. Accordingly, the digital twin can comprise a dynamic tokenized representation of quiescent or active behaviors of a specific PUM in a specific environment or represent a generalized model of a PUM in a generalized environment, which may be localized or used as-is. The tokenized behaviors can identify or name the observed behavior, thereby labeling the token (of Bevoken) as corresponding to a specifically identified behavior, and keeping the data used to reach that identification encrypted.

The degree of disclosure of the data sets pertaining to a PUM to a digital twin may be sufficient for the Digital Twin and any associated analytic or predictive processing to be able to undertake effective predictive, trend, underlying care framework identification or other care and wellness benefit processing. This can be achieved in a number of ways, employing differing embodiments, for example the tokens may include a set of specifications that can be interpreted by a suitably authorized digital twin that can access, potentially on a time or function limited basis the data that are deemed private by a PUM for a specified purpose. This type of disclosure may be agreed by a PUM in advance. The data received by the digital twin may be expunged after the appropriate analytics or processing has been undertaken. In some embodiments, the digital twin may operate as a proxy for a PUM, such that all data are available to a digital twin, and the digital twin acts as the privacy guardian of the PUM, enacting and enforcing the privacy choices of the PUM. In a further embodiment, there may be tokens that are digital twin specific and include further specifications determining the use, propagation, or configuration of the tokens and the digital twin operating upon them. Accordingly, the digital twin, through one or more configurations, retains a trust relationship with the PUM, such that the data a PUM deems private remain private, and the digital twin can function to support the care, wellness or safety monitoring of the PUM to the benefit of the PUM.

In various embodiments, a plurality of digital twins can be used to simulate a single PUM with different configurations or monitored behavioral, health, wellness or safety (BHWS) conditions so that each digital twin can produce different predictive results. For example, a first digital twin may be configured to monitor for the PUM falling, and is configured to represent the PUM in a distracted state (e.g., based on movement patterns trained on sleepy, feverish, or inattentive historical users), a second digital twin may be configured to monitor for the PUM falling, and is configured to represent the PUM in an alert state (e.g., based on movement patterns trained on rested, healthy, or assisted historical users), and a third digital twin may be configured to monitor the PUM for heart attacks (e.g., based on historical conditions of users when struck with a cardiac event).

In various embodiments, the digital twins may use, or be used in conjunction with, one or more game theory models to, at least in part, identify potential behaviors of the PUM expressed as data sets representing patterns or to rank those behavior sets into one or more ordered arrangements. In various embodiments, wherein the plurality of candidate next states can be analyzed as a Markov chain from the current state as contextual behaviors depending from the current state with the digital twins affecting the weightings of the next states in the chain from a current state.

At block 760, the edge AI/ML model identifies whether a predicted BHWS incident is included in the candidate next states. In various embodiments, a predicted BHWS incident is identified based on a number of candidate next states or a confidence of a candidate next state exceeding a threshold and being associated with an alert condition. When a predicted BHWS incident is identified, method 700 proceeds to block 790, but may continue monitoring the PUM and perform additional operations of method 700.

For example, when used to monitor a PUM for fall risk, a current state of the PUM and the SEE may be associated with a risk for the PUM falling, and at least one candidate state of the plurality of candidate states (identified per block 750) may indicate that the PUM is expected to fall within the next time window. The risk for falls may always be present for the particular PUM (because the PUM is under observation for falling), but various learned behaviors and environmental conditions can increase the likelihood of a fall occurring beyond an acceptable or every-day risk level. Accordingly, when more of the candidate next states include a fall than a threshold number or percentage of the plurality, an alert (per block 790) can be generated to avoid or mitigate the potential fall. In some embodiments, a confidence in a predicted BHWS event occurring may also trigger an alert, such as when a single digital twin of a plurality of digital twins reports a simulation that resulted in a BHWS event with a particular confidence score (regardless of the results of the other digital twins).

At block 770, the AI/ML model determines whether the PUM has deviated from the predicted candidate next states. A deviation from an expected behavior pattern may indicate that digital twins or other models are not accurately predicting the PUM's behaviors, that the PUM is acting erratically and should be checked on, or that a new behavior pattern is being displayed by the PUM, which may or may not be of interest for updating an AI/ML model. When a deviation is identified, method 700 proceeds to block 790, but may continue monitoring the PUM and perform additional operations of method 700. In various embodiments, when a next state occurs, (e.g., a new time window begins, a PUM moves from one region in the SEE to another region in the SEE, the PUM leaves or enters the SEE, a non-PUM entity leaves of enters the SEE, the PUM falls asleep or wakes, a PUM moves from one identified task to another identified task, etc.), the AI/ML model determines if the next state matches one or more of the identified candidate next states, and when the actual next state does not match at least one of the candidate next states, determines that a deviation has occurred.

At block 780, the AI/ML model updates the activity patterns of the PUM based on the observed activity patterns, which may include activities that resulted in normal daily activities being performed as expected, as well as immediate danger conditions, predicted behavioral, health, wellness or safety (BHWS) incidents (which may have occurred, been avoided, or mitigated), and deviations from normal/predicted daily activities. Because the edge AI/ML model is based on a generalized AI/ML model, localization may be constantly performed to adjust to the individual habits of the PUM and idiosyncrasies of the SEE. Additionally, the PUM may develop new behaviors and cease old behaviors and develop new health conditions that can be monitored for. Accordingly, monitoring and adjustment and updating of the activity patterns of the PUM may be part of a continuous process for monitoring the PUM.

In some examples, the BHWS incidents can include various incidents that may be classified as one or more than one of a behavioral incident, a health incident, a wellness incident, or a safety incident for various PUM. Additionally, BHWS incidents may include both “positive” and “negative” incidents, or be characterized in multiple ways. For example, a first PUM may be monitored for the presence of the behavior of “eating breakfast”, while a second PUM may be monitored for eh absence of the behavior (e.g., “skipping breakfast”), which may be classified as a behavior incident as well as a health incident, wellness incident, or a safety incident depending on the HCP for the PUM, and the occurrence or timing of the BWHS incident may be treated positively or negatively according to the HCP. For example, both the first and second PUM may need to avoid eating breakfast due to medications needing to be taken on an empty stomach, so “eating breakfast” may be handled as a negative incident (e.g., resulting in an alert), whereas “skipping breakfast” may be handled as a positive incident (e.g., not resulting in an alert). In a contrasting example, both the first and second PUM may need eat breakfast due to blood sugar requirements, so “skipping breakfast” may be handled as a negative incident (e.g., resulting in an alert), whereas “eating breakfast” may be handled as a positive incident (e.g., not resulting in an alert).

In various embodiments, BWHS incidents (or events) may be triggered via detection of a one-time or an ongoing condition in the SEE or affecting the PUM. For example, a BWHS incident may monitor whether a PUM has fallen, and is indicated in response to a sound, impact, positional sensor, or combination thereof indicating that the PUM has fallen. In another example, a BWHS incident may monitor whether the PUM is affected by a tachycardia condition, and is indicated in response to a heart rate monitor indicating a heart rate above a threshold rate for at least a threshold time (e.g., to avoid false positives from day-to-day excitements).

In various embodiments, BWHS incidents may interact with one another to trigger an alert when a single BWHS incident would not trigger an alert, or to prevent an alert when a single BWHS would trigger an alert. For example, a position sensor indicating that a PUM is horizontal or vertical and a sound level sensor may be used to help track where the PUM is located in the SEE; neither of which indicate a fall by itself, but both sensors are used in combination to detect when a threshold noise level is detected and change to the horizonal position is detected to generate a fall alert. In a further example, a heart rate monitor configured to generate an alert for a tachycardia condition may be temporarily overridden by a sensor included in an exercise machine indicating that the PUM is engaged in aerobic exercise; preventing a tachycardia alert despite the PUM experiencing a threshold heart rate for at least a threshold time.

The observed sensor data used to updated the activity patterns may be used to locally recalibrating the AI/ML edge model or collectively retraining the generalized AI/ML model. For example, when a threshold number of the plurality of candidate next states do not satisfy a confidence threshold, a behavioral, health, wellness or safety incident has occurred, a predefined length of time has passed, the PUM is removed from monitoring or the like, block 780 of method 700 can include providing data for updating the generalized AI/ML model. The provision of data includes anonymizing and sending the sensor data associated with the various states and behavior patterns of the PUM within the SEE to an aggregated data set for inclusion in a training data set for a next iteration of a generalized AI/ML model. These data may be tokenized, which allows for the relevant data to be identified without completely decrypting the transmitted data sets.

For example, block 780 of method 700 can return to (or be part of) block 720 to recalibrate the AI/ML edge model based on observed behavior patterns and the sensor data by adjusting weightings for identifying the plurality of candidate next states for a particular current state, wherein recalibrating the edge AI/ML model does not retrain the generalized AI/ML model. Local recalibration not only reduces the amount of computing resources used compared to retraining an AI/ML model (and transmitting the data to do so), but preserves the privacy of the data used, by keeping those data within the SEE or a local network for the SEE. Accordingly, in some embodiments, the edge AI/ML model deployed in the SEE (or in a local network that includes the SEE) can locally process the sensor data to not only generate the various alerts when deemed necessary, but also to locally adjust and optimize the conditions that result in alerts for the associated PUM and SEE, whereas the generalized model may be trained remotely from the local network for the SEE.

In various embodiments, the AI/ML edge model creates and updates localized activity patterns that identify repeated behaviors of the associated PUM, which may be built from generalized activity patterns included in the generalized AI/ML model, or built locally. The edge AI/ML model uses the sensor data associated with the various states of the SEE and the PUM to identify patterns among a sequence of states, which may be modeled in some embodiments as a Markov chain.

At block 790, the AI/ML model generates an alert. In various embodiments, the alert may be transmitted within the SEE or external to the SEE to address an ongoing or predicted BHWS event, with various amounts of encryption or tokenization applied thereto to maintain data privacy and reduce network load, while still addressing the underlying health concerns. Additionally, one or more alerts may be generated simultaneously or in sequence to one another when block 790 is performed. The alerts may include immediate danger alerts, predicted danger alerts, and deviation alerts depending on the circumstances in which the alert is generated (e.g., according to determinations made according to block 710, block 760, and block 770, respectively), and combinations thereof.

For example, when messaging internally within the SEE, the alert may be directed to the PUM or a stakeholder to determine whether an identified BHWS event actually occurred, and generate a response, which can include requesting permission for various follow up actions. For example, when monitoring a PUM for fall risk, a microphone detecting a loud sound and a positional sensor identifying that the PUM is in a prone position may result in a detection (per block 740) that the PUM has fallen. The AI/ML model may generate an alert within the SEE for a stakeholder or other caretaker present in the SEE to check on the PUM, for the PUM to self-report a status, etc. A responder to the alert in the SEE may indicate that a fall actually occurred and may positively authorize the AI/ML model in a reply to the internal alert to place an alert with an outside party (e.g., an ambulance service, emergency medical service provider, or non-emergency healthcare provider), indicate that a fall actually occurred and deny authorization for the AI/ML model to place an alert with an outside party, or indicate that no fall occurred (e.g., a false positive for a fall was detected).

For example, when messaging externally to the SEE, the alert may be directed to a stakeholder who has been preapproved for receiving certain classes of messages in certain situations. For example, a stakeholder of a relative may be contacted with an alert under condition set one, while emergency medical services may be contacted with an alert under condition set two.

In various embodiments, the external alerts are generated as tokens, which include various data sets that are encrypted, but are useable by recipients in an encrypted or partially decrypted form, and one token may include data encrypted for the exclusive use by some recipients but not others of a particular alert. For example, if an alert is generated in response to detecting that the PUM has fallen for transmission to a sets of three stakeholders of a primary care physician for the PUM, to a stakeholder of an ambulance service, and a stakeholder of a family member, the token may indicate to all three (in an unencrypted or partially decrypted state) that the PUM has suffered a fall. The alert may include data related to the lead-up to the fall and the behaviors and biometric information useful to the primary care physician, which may be of limited interest to the ambulance service or the family member (and of interest to the PUM to keep private). Similarly, the data unencryptable by the ambulance service may include address information and keycodes necessary to access the SEE (e.g., gate codes, security alarm codes, etc.) that are of limited interest to the primary care physician or the family member (and of interest to the PUM to keep private). Each stakeholder may receive the token and use, in a decrypted state, the portions that are relevant to their interested in monitoring and treating the PUM without accessing data not necessary or deemed private by the PUM for the alert-worthy situation.

Various data sets or functional models may be provided between different parties as tokens, which act to encrypt various portions of the data. For example, a token can comprise a detected data set representing behaviors of a PUM in an environment, wherein the token is encrypted using an encryption key. The tokens may contain the sensor data or may reference the data stored at the sensor. Other devices in the system or the server may make decisions on event response or escalation, without the need to access the information stored or referenced by the tokens—without decrypting the data, the token is deemed sufficient evidence of a determination or detection based on the data. Other devices within the system may obtain the data associated to the token and use those data to, for example, enhance the event detection accuracy or to confirm the event. For example, a device may interpret a combination of acceleration and change in altitude from sensors as a “fall” event for a PUM, and issue a token associated with the sensors' data and send that event token to the server and to a nearby edge device. While the server may trigger a notification to a call center or to smart speaker app to initiate a conversation with the PUM, the nearby edge device may use the token (and not the full set of data that resulted in the data), combined with its identification or other authorization key, to request the event data from the device and use it to confirm or add accuracy to the fall event, by combining the sensor data with data from its own sensors, for example audio signals from a microphone or microphone array, or output signals from one or more Frequency-Modulated Continuous-Wave (FMCW) radar sensors.

In some embodiments, the encryption key is selected based in part on the detected data set, the at least one stakeholder, on the person under care, a type of event detected by the environmental sensor, or is unique to a session of the person under care.

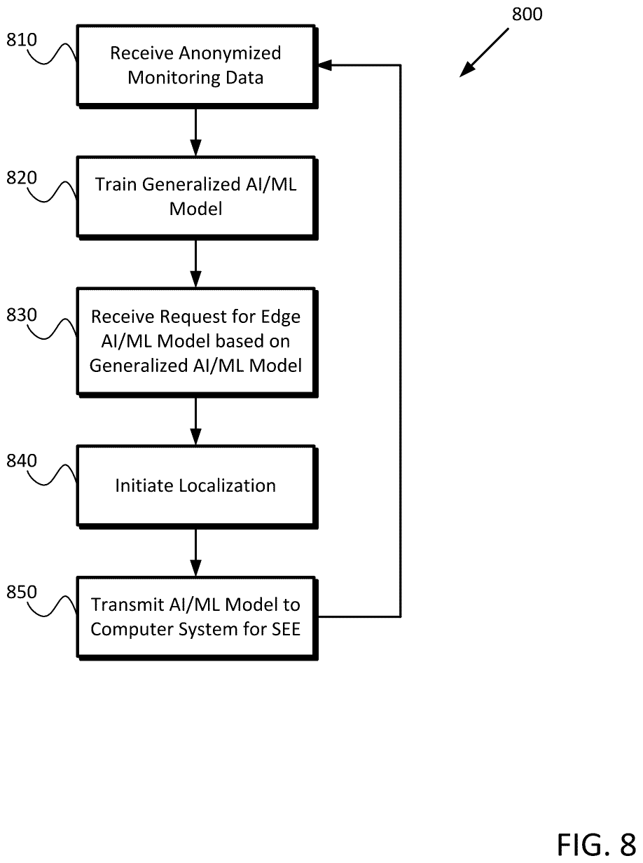

FIG. 8 is a flowchart of an example method 800 for generating and maintaining a generalized AI/ML model from localized monitoring, according to embodiments of the present disclosure.

At block 810, at a central service such as a model generation system receives anonymized data from a plurality of SEEs related to monitoring various PUM according to various associated HCP for those PUM. In various embodiments, these data are tokenized, so that tags identifying features of the data can be read without the need to decrypt all of an associated data set (e.g., to identify data relevant to a set of criteria, such as certain health conditions, certain locations of SEEs, demographic data for a type of PUM for whom the data were gathered, etc.). In various embodiments, the data are stripped of personally identifiable information or such information remains encrypted so that when data from multiple SEEs are received, the aggregated data are anonymized and information related to a particular SEE or particular PUM cannot be determined from the aggregated data set or otherwise linked back to the particular SEE or particular PUM. In various embodiments, the tokenized data identify whether a behavioral, health, wellness or safety event occurred, whether an alert was generated for a such event, whether the alert was a false or true positive or a false or true negative.

In some embodiments, a central service periodically or in response to a medical event occurring (e.g., the edge AI/ML model detecting alert condition per block 790 of method 700) receives updated information to continue improving the generalize models with. For example, a central service can receive from the computing device, tokenized alerts of BHWS events affecting the particular PUM identified via the edge AI/ML and update one or more data sets with the alert and data carried therein. Which data sets are updated may be based on one or more categories of the BHWS event or classification of the PUM that are readable in the tokenized alert matching or corresponding to one or more categories for training/retraining generalized AI/ML models for use PUMs having similar categories of health conditions monitored for or belonging to a similar category of PUM. For example, a tokenized alert can indicate that the token relates to a health alert of a fall affecting a person identified as between 60-80 years old, and is added to two data sets-one for persons who have fallen, and one for persons between 60-80 years old. The encrypted data in the tokenized alert can then be anonymously aggregated with the other data in the data set (e.g., reported data from sensors in the SEE, behaviors or activities identified as occurring prior to the fall, whether the fall was a false positive or true positive, whether the sensors and AI/ML missed identifying the fall (e.g., a false negative), whether the AI/ML model correctly predicted a fall occurring and helped mitigate or preemptively alert for a potential fall, etc.).

At block 820, a central service trains a generalized AI/ML model for monitoring a generalized PUM in a generalized SEE based on a selected data set generated from the received anonymized monitoring data (e.g., from block 810).

In various embodiments, the generalized AI/ML model is trained to include generalized sensor setting and generalized activity patterns for monitoring the generalized PUM in the generalized SEE. For example, a first PUM and a second PUM may each have a particular AI/ML model trained on unique behavior patterns and needs for the particular PUM, but such calibrated AI/ML models may be based on a generalized AI/ML model trained using data from one or both of the first PUM and the second PUM (and other PUM) and thereby provides behavior patterns that are amalgamated and generalized from the actually monitored behavior patterns of several unique PUM to represent the generalized behavior of a generalized PUM.

At block 830, a central service receives a request for an edge AI/ML model for a particular PUM associated with a particular SEE, the request being received from a computing device associated with the particular SEE, such as a computing device located within the SEE or in a local network that includes the SEE.

At block 840, a central service initiates localization operations for the edge AI/ML model for the particular SEE. In various embodiments, initiation of localization operations may include confirming that the requesting system is an authorized receiver for a generalize AI/ML model as described herein. In some embodiments, localization performed by the central service includes selecting one or more generalized AI/ML models based on supplied details related to the PUM, the SEE, or the HCP for the PUM received in the request. For example, a central service may retain a plurality of different generalized AI/ML models for various different combinations or PUM types, SEE types or locations, and HCP types, and initial localization includes selecting a particular available generalized AI/ML model from a repository for provision to the requesting system based on a similarity or a category matching procedure for the particular PUM, particular SEE, or particular HCP, or combinations thereof for the requesting system.

In various embodiments, one or both of a central service and a requesting system localizes the generalized AI/ML model by calibrating the generalized sensor settings within the generalized AI/ML model based on sensors within the particular SEE, physical characteristics of the particular SEE, and a health care plan (HCP) for the particular PUM; and calibrating the generalized activity patterns within the generalized AI/ML model based on the sensors within the particular SEE, the physical characteristics of the particular SEE, and the health care plan (HCP) for the particular PUM.

In various embodiments, the localization is initialized at a central service, and continues on a local computing device associated with the SEE (which may be the requesting device or a separately designated computing device). In some embodiments, a local computing device associated with the SEE receives the generalized AI/ML model and performs substantially all of the localization actions. In some embodiments, a central service localizes (or performs substantially all of an initial localization) on behalf of the SEE, and the local computing device associated with the SEE receives the edge AI/ML model from the central service.

In various embodiments, localization can include one or more of spatial calibrations, temporal calibrations, or behavioral/health calibrations. These localizations can include selecting initial patterns frameworks based on the spatial, temporal, or HCP data received related to the PUM or SEE, adjusting pattern frameworks based on the spatial, temporal, or HCP data received related to the PUM or SEE, learned information from monitoring the PUM and SEE, and combinations thereof.

For example, a spatial calibration can include identifying where the SEE is located geographically, how large the SEE is, how different regions within the SEE are organized, and combinations thereof to affect how and what alerting conditions are monitored for the PUM. For example, a generalized pattern framework can identify when certain behaviors result in an alert based on external temperatures so that opening a window when the weather is below, for example, 5 degrees Celsius or above, for example, 35 degree Celsius may result in generating an alert while opening the window between those temperatures does not. Accordingly, the AI/ML model can be spatially calibrated to take into consider local weather conditions while monitoring the PUM. Similarly, geographically relevant sunrise/sunset data (which may also be considered in temporal calibrations) can be included in spatial calibrations, as can pollen or air quality measures, precipitation, or the like.

In some examples, spatial calibration includes a layout of the SEE, so that a generalized behavior pattern of performing various sequential activities can be matched to the sensors at the relevant locations within the SEE. Accordingly, a behavior pattern data from sensors in a bedroom, an intervening hallway, and a kitchen are identified for monitoring a first PUM when performing a behavior of waking and walking to a kitchen in a first SEE, but that same behavior pattern can be matched to different sensors in different locations for a second PUM in a second SEE who travels from a bedroom directly to a front door (e.g., to collect a morning paper) and then a hallway to a kitchen.

In various embodiments, a temporal calibration can include identifying various absolute and relative times in which behaviors are expected to be performed. These calibrations can include adjusting the order of performance of individual behaviors within a pattern, durations of various behaviors within a pattern, a rigidity of adherence to a pattern (e.g., how concerning a deviation from a pattern should be treated), when a particular pattern/behavior occurs relative to absolute time (e.g., as indicated by a master clock), when a particular pattern/behavior occurs relative to another pattern/behavior, and combinations thereof.

For example, a general behavior pattern can indicate that the general PUM is expected to sleep between 7-9 hours any particular night, and that the duration of sleep is expected to occur in a time period between 9 pm and 9 am. However, local calibration of a sleep behavior can include that sleep should be expected to be divided into several shorter segments with visits to a bathroom therebetween, should last longer or shorter than the initial 7-9 hours, should occur for a different range of time, or should occur in a different time period, and combinations thereof. These local temporal calibrations can be based on PUM preferences or learned behaviors, and can also be affected by data included in an HCP. For example, when monitoring a first PUM for narcolepsy, sleep behavior outside of a prescribed absolute time period may be treated as an alerting condition, whereas a second PUM (not being observed for narcolepsy) taking a nap outside of a prescribed absolute time period may not be treated as an alerting condition on its own.

In various embodiments, a behavioral/health calibration can include identifying various behavioral patterns or health conditions to monitor for, and how to monitor for those behavioral patterns or health conditions according to data indicated in the HCP, available sensors in the SEE, and PUM preferences, among other inputs. These calibrations can include adjusting alerting thresholds for immediate safety or danger conditions, typical/atypical behavior patterns, and combinations thereof. For example, behavioral/health calibration can include identifying a heart rate sensor associated with a first PUM and monitoring the first PUM for heart arrhythmias according to the HCP, while behavioral/health calibration for a second PUM can include identifying a heart rate sensor associated with the second PUM and monitoring the second PUM for tachycardia according to the HCP (e.g., a different health condition using the same sensor).

For example, behavioral/health calibration for PUMs monitored for tachycardia may include ignoring, dampening, heightening tachycardia determinations based on recognized behavior patterns for the PUM and the expected (potentially beneficial) elevation of heart rate when so engaged. Accordingly, calibration can identify that when a PUM engages in day-to-day activities not associated with elevated heart rates, a first heart rate threshold should be used to detect negative tachycardia health events. This first threshold may be based on a resting heart rate specified in the HCP for a particular PUM, and may be adjusted based on observed heart rates and other health data included in the HCP or learned over time. Continuing the example, behavioral/health calibration can identify that when a PUM engages in various activities associated with elevated heart rates, such as rigorous exercise, a second heart rate threshold, greater than the first heart rate threshold, should be used to detect negative tachycardia health events (e.g., avoiding false positives). Similarly, behavioral/health calibration can identify that when a PUM engages in various activities associated with decreased heart rates, such as napping or watching television, a second heart rate threshold, less than the first heart rate threshold, should be used to detect negative tachycardia health events (e.g., avoiding false negatives, increasing early detection, etc.).

The present disclosure contemplates that the identified behaviors for individual PUM can be learned to further adjust the behavioral/health calibrations over time. For example, various activities for a first PUM may be identified as relaxing while identified for a second PUM as exciting (e.g., associated with nominally higher or lower heart rates, blood pressures, etc.) so that the thresholds and other monitoring criteria are locally calibrated accordingly.

At block 850, a central service transmits the AI/ML model to the requesting computing device. In various embodiments, the transmission may be provided over various network connections that use encryption to preserve data privacy of the AI/ML model provided to the receiving system, and the central service may send encryption/decryption keys to various designated computing devices to allow access to the transmitted AI/ML model or the tokenized communications that the AI/ML model will generate during use.

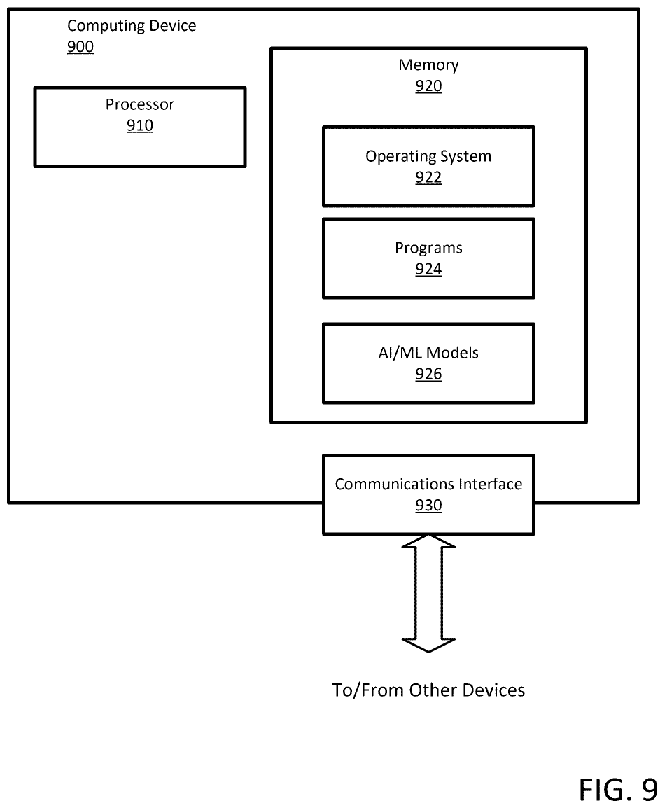

FIG. 9 illustrates an example computing device 900, as may be used as a controller in a SEE to monitor a PUM, as part of a sensor monitoring a PUM, as part of a central or distributed service providing calibration systems for generating and curating AI/ML models for distribution to the SEEs, and the like, according to embodiments of the present disclosure. For example, the computing device 900 may perform the operations set out in one or more of methods 600, 700, or 800. The computing device 900 may include at least one processor 910, a memory 920, and a communication interface 930.

The processor 910 may be any processing unit capable of performing the operations and procedures described in the present disclosure (e.g., methods 600, 700, 800). In various embodiments, the processor 910 can represent a single processor, multiple processors, a processor with multiple cores, and combinations thereof.

The memory 920 is an apparatus that may be either volatile or non-volatile memory and may include RAM, flash, cache, disk drives, and other computer readable memory storage devices. Although shown as a single entity, the memory 920 may be divided into different memory storage elements such as RAM and one or more hard disk drives. As used herein, the memory 920 is an example of a device that includes computer-readable storage media, and is not to be interpreted as transmission media or signals per se.

As shown, the memory 920 includes various instructions that are executable by the processor 910 to provide an operating system 922 to manage various features of the computing device 900 and one or more programs 924 to provide various functionalities to users of the computing device 900, which include one or more of the features and functionalities described in the present disclosure (e.g., method 600, 700, or 800). One of ordinary skill in the relevant art will recognize that different approaches can be taken in selecting or designing a program 924 to perform the operations described herein, including choice of programming language, the operating system 922 used by the computing device 900, and the architecture of the processor 910 and memory 920. Accordingly, the person of ordinary skill in the relevant art will be able to select or design an appropriate program 924 based on the details provided in the present disclosure.

Additionally, the memory 920 may include one or more AM/ML models 926 that interact with, are trained by, or are curated by the programs 924. The AI/ML models 926 may include generalized AI/ML models that are available for use (e.g., as a starting point) to various SEEs, as well as localized “edge” AI/ML models that are adjusted to reflect localized conditions in a particular SEE to better track and monitor a PUM, as described herein.

The communication interface 930 facilitates communications between the computing device 900 and other devices, including sensors in a SEE, which may also be computing devices as described in relation to FIG. 9. In various embodiments, the communication interface 930 includes antennas for wireless communications and various wired communication ports. The computing device 900 may also include or be in communication, via the communication interface 930, one or more input devices (e.g., a keyboard, mouse, pen, touch input device, etc.) and one or more output devices (e.g., a display, speakers, a printer, etc.).

Although not explicitly shown in FIG. 9, it should be recognized that the computing device 900 may be connected to one or more public and/or private networks via appropriate network connections via the communication interface 930. It will also be recognized that software instructions may also be loaded into a non-transitory computer readable medium, such as the memory 920, from an appropriate storage medium or via wired or wireless means.

The present disclosure may also be understood with respect to the following numbered clauses:

Clause 1: A method, comprising: receiving, for monitoring a particular person under monitoring (PUM) in a particular sensor enabled environment (SEE), an artificial intelligence or machine learning (AI/ML) model, the AI/ML model including sensor setting and activity patterns for monitoring a PUM in a SEE; localizing the AI/ML model as a calibrated AI/ML model, wherein localizing includes: calibrating the sensor settings within the AI/ML model as calibrated sensor settings based on sensors within the particular SEE, physical characteristics of the particular SEE, and a health care plan (HCP) for the particular PUM; calibrating the activity patterns within the AI/ML model as calibrated activity patterns based on the sensors within the particular SEE, the physical characteristics of the particular SEE, and the health care plan (HCP) for the particular PUM; monitoring sensor data from the sensors to monitor the particular PUM within the particular SEE to identify a current state of the particular PUM and the particular SEE; identifying, via the calibrated AI/ML model, a plurality of candidate next states for the particular PUM and the particular SEE based on the current state and the activity patterns; in response to a next state occurring, locally updating the activity patterns using the sensor data associated with the next state to create a localized activity pattern that identifies repeated behaviors of the particular PUM; and in response to the next state not matching at least one candidate next state of the plurality of candidate next states based on the localized activity pattern, generating an alert.

Clause 2: The method of any of clauses 1 and 3-15, wherein the plurality of candidate next states includes at least one behavioral, health, welfare, or safety (BHWS) incident next state associated with conditions historically leading to a BHWS incident, wherein the method further comprises: in response to a probability of the BHWS incident next state exceeding an alert threshold, transmitting an alert message to the PUM or a stakeholder associated with the PUM before identifying a subsequent occurrence of the BHWS incident.

Clause 3: The method of any of clauses 1-2 and 4-15, wherein when a threshold number of the plurality of candidate next states do not satisfy a confidence threshold, the method further comprises: anonymizing and sending the sensor data associated with the next state and a behavior pattern of the PUM within the SEE to an aggregated data set for inclusion in a training data set for a next iteration of the AI/ML model.

Clause 4: The method of any of clauses 1-3 and 4-15, wherein anonymizing the data includes tokenizing the data within a dataset for training of the AI/ML model.

Clause 5: The method of any of clauses 1-4 and 6-15, further comprising: recalibrating the calibrated AI/ML model based on observed behavior patterns and the sensor data by adjusting weightings for identifying the plurality of candidate next states for a particular current state, wherein recalibrating the calibrated AI/ML model does not retrain the AI/ML model.

Clause 6: The method of any of clauses 1-5 and 7-15, wherein the plurality of candidate next states are analyzed as a Markov chain from the current state as contextual behaviors depending from the current state.

Clause 7: The method of any of clauses 1-6 and 8-15, wherein when the current state corresponds to an immediate danger state, generating an alert for transmission to a stakeholder.

Clause 8: The method of any of clauses 1-7 and 9-15, wherein monitoring the sensor data further includes: synthesizing a synthetic data set for a value not directly measured by the sensors within the particular SEE from at least two sensor data sets directly measured by the sensors within the particular SEE.

Clause 9: The method of any of clauses 1-8 and 10-15, wherein calibrating the activity patterns includes applying spatial calibrations based on a location or layout of the SEE to the activity patterns.

Clause 10: The method of any of clauses 1-9 and 11-15, wherein calibrating the activity patterns includes applying temporal calibrations based on timings of behaviors of the particular PUM relative to the activity patterns.

Clause 11: The method of any of clauses 1-10 and 12-15, wherein calibrating the activity patterns includes applying a behavior/health calibration based on characteristics of behaviors performed by the particular PUM and medical conditions to monitor in the particular HCP.

Clause 12: The method of any of clauses 1-11 and 13-15, wherein the sensor data are processed locally within a network that includes the particular SEE, and the AI/ML model is trained remotely from the network.

Clause 13: The method of any of clauses 1-12 and 14-15, wherein the plurality of candidate next states are generated according to a game theory-based model of PUM behavior.

Clause 14: The method of any of clauses 1-13 and 15, wherein the plurality of candidate next states are generated according to simulated actions of one or more digital twins of the PUM.

Clause 15: The method of any of clauses 1-14, wherein behaviors and locations of one or more non-PUM persons who are present in the particular SEE are observed in the particular SEE as part of determining the current state and for generating the plurality of candidate next states.

Clause 16: A method, comprising: receiving, at a central service, anonymized data from a plurality of sensor enabled environments (SEE) related to monitoring various persons under monitoring (PUM) according to various associated health care plans (HCP); training, at the central service, an artificial intelligence or machine learning (AI/ML) model for monitoring a PUM in a SEE, the AI/ML model including sensor settings and activity patterns for monitoring the PUM in the SEE; receiving, at the central service, a request for a calibrated AI/ML model for a particular PUM associated with a particular SEE, the request being received from a computing device associated with the particular SEE; initiating, at the central service, localization operations to generate the calibrated AI/ML model for the particular SEE; and transmitting the calibrated AI/ML to the computing device, wherein the localization operations include: calibrating the sensor settings within the AI/ML model as calibrated sensor settings based on sensors within the particular SEE, physical characteristics of the particular SEE, and a particular HCP for the particular PUM; and calibrating the activity patterns within the AI/ML model as calibrated activity patterns based on the sensors within the particular SEE, the physical characteristics of the particular SEE, and the particular HCP for the particular PUM.

Clause 17: The method of any of clauses 16 and 18-20, wherein at least part of the localization operations are performed by the computing device associated with the particular SEE.

Clause 18: The method of any of clauses 16-17 and 19-20, wherein the calibrated AI/ML model models behaviors of the particular PUM via one or more digital twins configured to programmatically simulate behaviors of the particular PUM based on sensor data collected in the particular SEE and historically observed behavior patterns of the particular PUM.

Clause 19: The method of any of clauses 16-18 and 20, further comprising: receiving, at the central service, a second request for a second calibrated AI/ML model for a second particular PUM associated with a second particular SEE, the second request being received from a second computing device associated with the second particular SEE; initiating, at the central service, second localization operations for the second calibrated AI/ML model for the second particular SEE; and transmitting the second calibrated AI/ML to the second computing device, wherein the second calibrated AI/ML model is generated from the AI/ML model using different localization data than are used in the localization operations for initializing the calibrated AI/ML model to calibrate the second calibrated AI/ML model for the second particular PUM and the second particular SEE.

Clause 20: The method of any of clauses 16-19, further comprising: receiving, at the central service from the computing device, tokenized alerts of behavioral, health, welfare, or safety (BHWS) events affecting the particular PUM identified via the calibrated AI/ML; and updating a data set based on one or more categories of the BHWS event or classification of the PUM to retrain the AI/ML model for use in monitoring PUMs monitored for a corresponding category of BHWS event or belonging to a corresponding classification of PUM.

Clause 21: A system, comprising: a processor; and a memory, including instructions that, when executed by the processor, perform operations as described in any of clauses 1-20.

Clause 22: A non-volatile memory storage device including instructions that, when executed by a processor, perform operations as described in any of clauses 1-20.

Clause 23: A sensor enabled environment (SEE) including a plurality of sensors disposed at various locations that is configured to: receive, for monitoring a particular person under monitoring (PUM) in the SEE, an artificial intelligence or machine learning (AI/ML) model, the AI/ML model including sensor setting and activity patterns for monitoring a PUM in an environment; localize the AI/ML model as a calibrated AI/ML model, wherein localizing includes: calibrating the sensor settings within the AI/ML model as calibrated sensor settings based on sensors within the SEE, physical characteristics of the SEE, and a health care plan (HCP) for the particular PUM; calibrating the activity patterns within the AI/ML model as calibrated activity patterns based on the plurality of sensors within the SEE, the physical characteristics of the SEE, and the health care plan (HCP) for the particular PUM; monitoring sensor data from the plurality of sensors to monitor the particular PUM within the SEE to identify a current state of the particular PUM and the SEE; identifying, via the calibrated AI/ML model, a plurality of candidate next states for the particular PUM and the SEE based on the current state and the activity patterns; in response to a next state occurring, locally updating the activity patterns using the sensor data associated with the next state to create a localized activity pattern that identifies repeated behaviors of the particular PUM; and in response to the next state not matching at least one candidate next state of the plurality of candidate next states based on the localized activity pattern, generating an alert.

Clause 24: The SEE of clause 23, wherein the AI/ML model is localized for the treatment or prophylaxis of at least one health condition in the HCP.

Systems, methods, and apparatuses of the present disclosure may be implemented on a variety of devices, such as but not limited to IPUs, DPUs, CPUs, GPUs, ASICs, FPGAs, DSPs, or any other device capable of processing data. Instructions for performing the same may be provided as hardware or firmware on any computer-readable medium including volatile and non-volatile forms of memory. Particular implementations of techniques of the present disclosure may be structured in any number of ways, including but not limited to a modular program architecture, a monolithic program architecture, on a single device, and distributed across more than one device or processor.

Although certain figures and descriptions have been provided, many additional variations and modifications will be apparent to those of skill in the art. It will be appreciated that presenting all possible variations and modifications is an impractical task, and thus any sequence, particular structural or device implementation, or underlying technique of the present disclosure may be substituted or modified to meet the needs of particular implementations, and that doing so may not depart from the scope of the present disclosure. It will therefore be appreciated that the examples presented herein are presented for illustrative purposes only, and are in no way intended to be limiting of a scope of the present disclosure. It will also be apparent to any individual of skill in the art that various embodiments described herein and elements thereof may be combined as needed to suit any particular implementation, and that doing so does not depart from the scope of the present disclosure. As such, the scope of the present disclosure is not to be understood as being limited by the figures or specification presented herein; the scope of the present disclosure should instead be understood in a context of the appended claims and their equivalents.

Certain terms are used throughout the description and claims to refer to particular features or components. As one skilled in the art will appreciate, different persons may refer to the same feature or component by different names. This document does not intend to distinguish between components or features that differ in name but not function.

As used herein, the term “optimize” and variations thereof, is used in a sense understood by data scientists to refer to actions taken for continual improvement of a system relative to a goal. An optimized value will be understood to represent “near-best” value for a particular reward framework, which may oscillate around a local maximum or a global maximum for a “best” value or set of values, which may change as the goal changes or as input conditions change. Accordingly, an optimal solution for a first goal at a particular time may be suboptimal for a second goal at that time or suboptimal for the first goal at a later time.

As used herein, “about,” “approximately” and “substantially” are understood to refer to numbers in a range of the referenced number, for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole numbers, or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in the present disclosure, the term “or” is to be interpreted in the inclusive sense and not the exclusive sense unless explicitly stated otherwise or when clear from the context. Accordingly, recitation of “A or B” is intended to cover the sets of A, B, and A-B, where the sets may include one or multiple instances of a particular member (e.g., A-A, A-A-A, A-A-B, etc.) and any ordering thereof.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, A-C, and A-B-C, where the sets may include one or multiple instances of a particular member (e.g., A-A, A-A-A, A-A-B, A-A-B-B-C-C-C, etc.) and any ordering thereof. For avoidance of doubt, the phrase “at least one of A, B, and C” shall not be interpreted to mean “at least one of A, at least one of B, and at least one of C”.

As used in the present disclosure, the term “determining” encompasses a variety of actions that may include calculating, computing, processing, deriving, investigating, identifying, looking up (e.g., via a table, database, or other data structure), ascertaining, receiving (e.g., receiving information), accessing (e.g., accessing data in a memory), retrieving, resolving, selecting, choosing, establishing, and the like.

Without further elaboration, it is believed that one skilled in the art can use the preceding description to use the claimed inventions to their fullest extent. The examples and aspects disclosed herein are to be construed as merely illustrative and not a limitation of the scope of the present disclosure in any way. It will be apparent to those having skill in the art that changes may be made to the details of the above-described examples without departing from the underlying principles discussed. In other words, various modifications and improvements of the examples specifically disclosed in the description above are within the scope of the appended claims. For instance, any suitable combination of features of the various examples described is contemplated.

Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112(f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

1. A method, comprising:
receiving, for monitoring a particular person under monitoring (PUM) in a particular sensor enabled environment (SEE), an artificial intelligence or machine learning (AI/ML) model, the AI/ML model including sensor setting and activity patterns for monitoring a PUM in a SEE;
localizing the AI/ML model as a calibrated AI/ML model, wherein localizing includes:
calibrating the sensor settings within the AI/ML model as calibrated sensor settings based on sensors within the particular SEE, physical characteristics of the particular SEE, and a health care plan (HCP) for the particular PUM;
calibrating the activity patterns within the AI/ML model as calibrated activity patterns based on the sensors within the particular SEE, the physical characteristics of the particular SEE, and the health care plan (HCP) for the particular PUM;
monitoring sensor data from the sensors to monitor the particular PUM within the particular SEE to identify a current state of the particular PUM and the particular SEE;
identifying, via the calibrated AI/ML model, a plurality of candidate next states for the particular PUM and the particular SEE based on the current state and the activity patterns;
in response to a next state occurring, locally updating the activity patterns using the sensor data associated with the next state to create a localized activity pattern that identifies repeated behaviors of the particular PUM; and
in response to the next state not matching at least one candidate next state of the plurality of candidate next states based on the localized activity pattern, generating an alert.

2. The method of claim 1, wherein the plurality of candidate next states includes at least one behavioral, health, welfare, or safety (BHWS) incident next state associated with conditions historically leading to a BHWS incident, wherein the method further comprises:
in response to a probability of the BHWS incident next state exceeding an alert threshold, transmitting an alert message to the PUM or a stakeholder associated with the PUM before identifying a subsequent occurrence of the BHWS incident.

3. The method of claim 1, wherein when a threshold number of the plurality of candidate next states do not satisfy a confidence threshold, the method further comprises:
anonymizing and sending the sensor data associated with the next state and a behavior pattern of the PUM within the SEE to an aggregated data set for inclusion in a training data set for a next iteration of the AI/ML model.

4. The method of claim 3, wherein anonymizing the data includes tokenizing the data within a dataset for training of the AI/ML model.

5. The method of claim 1, further comprising:
recalibrating the calibrated AI/ML model based on observed behavior patterns and the sensor data by adjusting weightings for identifying the plurality of candidate next states for a particular current state, wherein recalibrating the calibrated AI/ML model does not retrain the AI/ML model.

6. The method of claim 1, wherein the plurality of candidate next states are analyzed as a Markov chain from the current state as contextual behaviors depending from the current state.

7. The method of claim 1, wherein when the current state corresponds to an immediate danger state, generating an alert for transmission to a stakeholder.

8. The method of claim 1, wherein monitoring the sensor data further includes:
synthesizing a synthetic data set for a value not directly measured by the sensors within the particular SEE from at least two sensor data sets directly measured by the sensors within the particular SEE.

9. The method of claim 1, wherein calibrating the activity patterns includes applying spatial calibrations based on a location or layout of the SEE to the activity patterns.

10. The method of claim 1, wherein calibrating the activity patterns includes applying temporal calibrations based on timings of behaviors of the particular PUM relative to the activity patterns.

11. The method of claim 1, wherein calibrating the activity patterns includes applying a behavior/health calibration based on characteristics of behaviors performed by the particular PUM and medical conditions to monitor in the particular HCP.

12. The method of claim 1, wherein the sensor data are processed locally within a network that includes the particular SEE, and the AI/ML model is trained remotely from the network.

13. The method of claim 1, wherein the plurality of candidate next states are generated according to a game theory-based model of PUM behavior.

14. The method of claim 1, wherein the plurality of candidate next states are generated according to simulated actions of one or more digital twins of the PUM.

15. The method of claim 1, wherein behaviors and locations of one or more non-PUM persons who are present in the particular SEE are observed in the particular SEE as part of determining the current state and for generating the plurality of candidate next states.

16. A method, comprising:
receiving, at a central service, anonymized data from a plurality of sensor enabled environments (SEE) related to monitoring various persons under monitoring (PUM) according to various associated health care plans (HCP);
training, at the central service, an artificial intelligence or machine learning (AI/ML) model for monitoring a PUM in a SEE, the AI/ML model including sensor settings and activity patterns for monitoring the PUM in the SEE;
receiving, at the central service, a request for a calibrated AI/ML model for a particular PUM associated with a particular SEE, the request being received from a computing device associated with the particular SEE;
initiating, at the central service, localization operations to generate the calibrated AI/ML model for the particular SEE; and
transmitting the calibrated AI/ML to the computing device,
wherein the localization operations include:
calibrating the sensor settings within the AI/ML model as calibrated sensor settings based on sensors within the particular SEE, physical characteristics of the particular SEE, and a particular HCP for the particular PUM; and
calibrating the activity patterns within the AI/ML model as calibrated activity patterns based on the sensors within the particular SEE, the physical characteristics of the particular SEE, and the particular HCP for the particular PUM.

17. The method of claim 16, wherein at least part of the localization operations are performed by the computing device associated with the particular SEE.

18. The method of claim 16, wherein the calibrated AI/ML model models behaviors of the particular PUM via one or more digital twins configured to programmatically simulate behaviors of the particular PUM based on sensor data collected in the particular SEE and historically observed behavior patterns of the particular PUM.

19. The method of claim 16, further comprising:
receiving, at the central service, a second request for a second calibrated AI/ML model for a second particular PUM associated with a second particular SEE, the second request being received from a second computing device associated with the second particular SEE;
initiating, at the central service, second localization operations for the second calibrated AI/ML model for the second particular SEE; and
transmitting the second calibrated AI/ML to the second computing device,
wherein the second calibrated AI/ML model is generated from the AI/ML model using different localization data than are used in the localization operations for initializing the calibrated AI/ML model to calibrate the second calibrated AI/ML model for the second particular PUM and the second particular SEE.

20. The method of claim 16, further comprising:
receiving, at the central service from the computing device, tokenized alerts of behavioral, health, welfare, or safety (BHWS) events affecting the particular PUM identified via the calibrated AI/ML; and
updating a data set based on one or more categories of the BHWS event or classification of the PUM to retrain the AI/ML model for use in monitoring PUMs monitored for a corresponding category of BHWS event or belonging to a corresponding classification of PUM.

21-42. (canceled)
